(19) United States
(12) Patent Application Publication
(10) Pub. No.: US 2026/0220455 A1
(43) Pub. Date: Jul. 30, 2026

(54) Technique For Transforming Artificial Intelligence Model For Performance Optimization Of Artificial Intelligence Model

(71) Applicant: NOTA, INC., Daejeon (KR)

(72) Inventor: Shinkook CHOI, Daejeon (KR)

(73) Assignee: NOTA, INC., Daejeon (KR)

(21) Appl. No.: 19/313,439

(22) Filed: Aug. 28, 2025

(30) Foreign Application Priority Data
Jan. 24, 2025 (KR) 10-2025-0011968
Jan. 25, 2025 (KR) 10-2025-0012056
Jul. 21, 2025 (KR) 10-2025-0098089

(51) Int. Cl. G06N 3/08; G06F 16/901; G06F 16/908; G06N 3/045

(52) U.S. Cl. CPC G06N 3/08; G06F 16/9017; G06F 16/908; G06N 3/045

(57) ABSTRACT

A method for transforming an artificial intelligence model for performance optimization of the artificial intelligence model is disclosed. The method comprises: receiving a first query for identifying a target artificial intelligence model to be subjected to transformation, and a second query for identifying a target platform on which the target artificial intelligence model is to be executed, accessing a scenario database that stores a plurality of transformation scenarios, and determining a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model and transforming the target artificial intelligence model by applying target model optimization tools included in the target transformation scenario to the target artificial intelligence model.

### CROSS-REFERENCE TO RELATED APPLICATIONS

This application claims priority to and the benefit of Korean Patent Application No. 10-2025-0098089 filed in the Korean Intellectual Property Office on 21 Jul. 2025, Korean Patent Application No. 10-2025-0011968 filed in the Korean Intellectual Property Office on 24 Jan. 2025 and Korean Patent Application No. 10-2025-0012056 filed in the Korean Intellectual Property Office on 25 Jan. 2025, the entire contents of which are incorporated herein by reference.

### TECHNICAL FIELD

This disclosure relates to artificial intelligence technology, and more particularly, to technique for transforming artificial intelligence model for performance optimization of artificial intelligence model.

### BACKGROUND ART

With the advancement of artificial intelligence technology, artificial intelligence models are showing innovative results in various fields such as image recognition, natural language processing, and speech recognition. These artificial intelligence models are mostly designed to perform specific tasks by learning a vast amount of data, and their performance tends to be proportional to the complexity of the model and the amount of training data. As the complexity of the model increases, the required amount of computation and memory usage also increase exponentially.

In particular, as the processing speed of processors increases, large-scale artificial intelligence models are emerging, and these large-scale artificial intelligence models include parameters numbering in the billions. A vast amount of computing resources is required to train and perform inference on these models. The use of computing resources can lead to high operating costs in a cloud environment, and becomes a major limiting factor that makes the deployment and utilization of models difficult in environments with limited resources, such as edge devices.

To solve these problems, research on optimization techniques for artificial intelligence models is being conducted. Optimization techniques may include methods such as compression and quantization. For example, compression can reduce the size of a model and decrease unnecessary computations by removing parameters or connections that do not significantly contribute to the model's performance. Quantization can reduce memory usage and the amount of computation by representing the model's parameters and activation values with a lower bit width.

European Patent Publication EP 4439275 A1 can be considered prior art.

### SUMMARY OF THE INVENTION

The present disclosure has been devised in response to the aforementioned background art, and has an object of efficiently achieving model optimization for an artificial intelligence model.

Technical objects of the present disclosure are not restricted to the technical object mentioned above. Other unmentioned technical objects will be apparently appreciated by those skilled in the art by referencing the following description.

According to an embodiment of the present disclosure, a method, performed by a computing device, for transforming an artificial intelligence model for performance optimization of the artificial intelligence model is disclosed. The method comprises: receiving a first query for identifying a target artificial intelligence model to be subjected to transformation, and a second query for identifying a target platform on which the target artificial intelligence model is to be executed, accessing a scenario database that stores a plurality of transformation scenarios, and determining a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model, and transforming the target artificial intelligence model by applying target model optimization tools included in the target transformation scenario to the target artificial intelligence model.

In an embodiment of the present disclosure, each of the plurality of transformation scenarios identifies a second combination of the model optimization tools for a first combination of an artificial intelligence model and a platform, the model optimization tools comprise at least a compressor, a graph optimizer, and a quantizer, and the platform comprises at least one of: a hardware on which an artificial intelligence model is to be executed, a compiler for connecting an artificial intelligence model to a hardware, and a runtime indicating an environment of a hardware on which an artificial intelligence model is to be executed.

In an embodiment of the present disclosure, each of the plurality of transformation scenarios identifies an order in which the model optimization tools are applied to an artificial intelligence model, for a first combination of an artificial intelligence model and a platform.

In an embodiment of the present disclosure, the transforming the target artificial intelligence model by applying the target model optimization tools included in the target transformation scenario to the target artificial intelligence model comprises: transforming the target artificial intelligence model by sequentially applying the target model optimization tools to the target artificial intelligence model according to the order identified in the target transformation scenario.

In an embodiment of the present disclosure, the order in which the model optimization tools are applied to the artificial intelligence model, which is identified in each of the plurality of transformation scenarios, is determined based on a performance change prediction value by each of the model optimization tools and a constraint according to the platform.

In an embodiment of the present disclosure, the determining the target transformation scenario comprises: calculating a model similarity between the target artificial intelligence model in the first query and models stored in the scenario database; and determining the target transformation scenario to be applied to the target artificial intelligence model among the plurality of transformation scenarios, by using the model similarity, the target platform in the second query and a target performance value specified by a user as conditions.

In an embodiment of the present disclosure, the determining the target transformation scenario comprises: calculating a model similarity between the target artificial intelligence model in the first query and models stored in the scenario database, determining a reference artificial intelligence model corresponding to the target artificial intelligence model among the models stored in the scenario database, based on a result of the calculation of the model similarity, and determining a scenario that is mapped to a target performance value specified by a user and the target platform as the target transformation scenario, based on the reference artificial intelligence model.

In an embodiment of the present disclosure, wherein the scenario database has a table structure comprising: identification information of an artificial intelligence model or identification information of a block of an artificial intelligence model, identification information of a model optimization tool or identification information of an optimization scheme, and performance information related to an artificial intelligence model to which the model optimization tool or the optimization scheme has been applied.

In an embodiment of the present disclosure, each of the plurality of transformation scenarios indicates a performance prediction value for a first combination of an artificial intelligence model and a platform, when the model optimization tools are applied to the artificial intelligence model, and the performance prediction value is an expected execution performance of an artificial intelligence model when the artificial intelligence model to which the model optimization tools have been applied is executed on a platform, and comprises at least one of: an accuracy of the artificial intelligence model, an inference speed of the artificial intelligence model and a degree of lightweighting of the artificial intelligence model.

In an embodiment of the present disclosure, the performance prediction value is generated by: dividing an artificial intelligence model into blocks comprising one or more operators, measuring a sub-execution performance for each combination unit of a block and a model optimization tool, by applying each of the model optimization tools to each of the divided blocks, and estimating an amount of change in execution performance of the artificial intelligence model when each of the model optimization tools is applied, by combining the measured sub-execution performances for each of the blocks constituting the artificial intelligence model.

In an embodiment of the present disclosure, the receiving the first query and the second query comprises: receiving the first query, the second query, and a target performance value that serves as a criterion for the transformation of the target artificial intelligence model, and the determining the target transformation scenario among the plurality of transformation scenarios comprises: determining the target transformation scenario to be applied to the target artificial intelligence model among the plurality of transformation scenarios, by using the first query, the second query and a comparison result between the target performance value and the performance prediction value.

In an embodiment of the present disclosure, the determining the target transformation scenario to be applied to the target artificial intelligence model among the plurality of transformation scenarios comprises: determining an execution mode of the target artificial intelligence model as one of an eager execution mode and a graph execution mode, based on an execution scheme of the target artificial intelligence model, from the first query, wherein the eager execution mode is a scheme of executing operations in an artificial intelligence model without converting to a graph, and the graph execution mode is a scheme of converting operations to a graph before execution of the artificial intelligence model, and determining filtered transformation scenarios that include the determined execution mode among the plurality of transformation scenarios by using the determined execution mode as a filtering criterion, and determining the target transformation scenario to be applied to the target artificial intelligence model among the filtered transformation scenarios.

In an embodiment of the present disclosure, the transforming the target artificial intelligence model by applying the target model optimization tools included in the target transformation scenario to the target artificial intelligence model comprises: generating a performance verification result including an estimated inference simulation result for a case where the transformed target artificial intelligence model is executed on the target platform, by applying, through a simulator, the target model optimization tools included in the target transformation scenario to the target artificial intelligence model according to an order specified in the target transformation scenario, without executing the transformed target artificial intelligence model on the target platform.

In an embodiment of the present disclosure, the method further comprises: comparing the performance verification result of the transformed target artificial intelligence model with a performance prediction value mapped to the target transformation scenario, determining whether to modify the target transformation scenario based on a result of the comparing, and when it is determined that the target transformation scenario is to be modified, changing a parameter of at least one of the target model optimization tools included in the target transformation scenario, and performing a second transformation of the target artificial intelligence model by applying the target model optimization tools including the changed parameter to the target artificial intelligence model in its state prior to the transformation.

In an embodiment of the present disclosure, the scenario database is constructed by: receiving first information for identifying a candidate artificial intelligence model and second information for identifying a candidate platform on which the candidate artificial intelligence model is to be executed, generating a block analysis result for blocks constituting the candidate artificial intelligence model by using the first information, and generating a platform analysis result indicating a constraint for the candidate platform by using the second information, generating a performance prediction value for a combination of the candidate artificial intelligence model and the candidate platform when a candidate model optimization tool is applied to the candidate artificial intelligence model, by using the block analysis result and the platform analysis result, and generating a candidate transformation scenario comprising the first information, the second information, the candidate model optimization tool, and the performance prediction value.

In an embodiment of the present disclosure, the block analysis result comprises: an inference accuracy of the candidate artificial intelligence model, predicted in units of a block comprising one or more operators constituting the candidate artificial intelligence model. and an execution mode of the candidate artificial intelligence model. The platform analysis result comprises: a constraint condition of the candidate platform, an operator supported by the candidate platform, a data type supported by the candidate platform, and an execution unit of the candidate platform.

In an embodiment of the present disclosure, the generating the candidate transformation scenario comprises: generating a first order rule indicating an application order of a plurality of candidate model optimization tools according to an execution mode of the candidate artificial intelligence model, and generating a second order rule indicating the application order of the plurality of candidate model optimization tools by using a correlation between the plurality of candidate model optimization tools, and generating the candidate transformation scenario including an execution order in which the plurality of candidate model optimization tools are executed on the candidate artificial intelligence model, by using the first order rule and the second order rule.

In an embodiment of the present disclosure, the generating the candidate transformation scenario comprises: generating a performance change prediction value corresponding to each of a plurality of candidate model optimization tools, and determining a candidate model optimization tool to be matched with the combination of the first information and the second information among the plurality of candidate model optimization tools, in descending order of a quantitative value of performance change within the performance change prediction value and by giving priority to inference speed.

In an embodiment of the present disclosure, a non-transitory computer-readable medium storing a computer program is disclosed. The computer program, when executed by a computing device, causes the computing device to perform operations for transforming an artificial intelligence model for performance optimization of the artificial intelligence model. The operations comprises: receiving a first query for identifying a target artificial intelligence model to be subjected to transformation, and a second query for identifying a target platform on which the target artificial intelligence model is to be executed, accessing a scenario database that stores a plurality of transformation scenarios, and determining a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model, and transforming the target artificial intelligence model by applying target model optimization tools included in the target transformation scenario to the target artificial intelligence model.

In an embodiment of the present disclosure, a computing device for transforming an artificial intelligence model for performance optimization of the artificial intelligence model is disclosed. The computing device comprises at least one processor configured to: receive a first query for identifying a target artificial intelligence model to be subjected to transformation, and a second query for identifying a target platform on which the target artificial intelligence model is to be executed, access a scenario database that stores a plurality of transformation scenarios, and determine a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model, and transform the target artificial intelligence model by applying target model optimization tools included in the target transformation scenario to the target artificial intelligence model.

According to some embodiments of the present disclosure, model optimization for an artificial intelligence model can be achieved through the efficient use of computing resources.

According to some embodiments of the present disclosure, model optimization tools to be used for the transformation of an artificial intelligence model can be efficiently arranged and/or applied in accordance with the artificial intelligence model and a platform.

According to some embodiments of the present disclosure, an artificial intelligence model optimized to be suitable for a target platform can be generated.

The effects obtainable from the present disclosure are not limited to the effects mentioned above, and other effects not mentioned will be clearly understood by one of ordinary skill in the art to which the present disclosure pertains from the following description.

### BRIEF DESCRIPTION OF THE DRAWINGS

Various aspects will now be described with reference to the drawings, wherein like reference numerals are used to refer to like elements throughout. In the following description, for purposes of explanation, numerous specific details are set forth in order to provide a thorough understanding of one or more aspects. However, it will be evident that such aspect(s) may be practiced without these specific details. In other instances, well-known structures and devices are shown in block diagram form to facilitate describing one or more aspects.

FIG. 1 is a block diagram of a computing device for transforming an artificial intelligence model for performance optimization of the artificial intelligence model according to an embodiment of the present disclosure.

FIG. 2 is a schematic diagram illustrating a network function according to an embodiment of the present disclosure.

FIG. 3 is a flowchart illustrating a method for transforming an artificial intelligence model for performance optimization of the artificial intelligence model according to an embodiment of the present disclosure.

FIG. 4 is a diagram illustratively showing a transformation scenario preparation process and a transformation scenario execution process according to an embodiment of the present disclosure.

FIG. 5 is a diagram illustratively showing a transformation scenario preparation process according to an embodiment of the present disclosure.

FIG. 6 is a diagram illustratively showing a process of generating a block analysis result and information included in a scenario database according to an embodiment of the present disclosure.

FIG. 7 is a diagram illustratively showing information included in a scenario database according to an embodiment of the present disclosure.

FIG. 8 is a diagram illustratively showing transformation scenarios in a scenario database according to an embodiment of the present disclosure.

FIG. 9 is a diagram illustratively showing a transformation scenario execution process according to an embodiment of the present disclosure.

FIG. 10 is a simplified and general schematic diagram of an exemplary computing environment in which embodiments of the present disclosure may be implemented.

### DETAILED DESCRIPTION

Various exemplary embodiments will now be described with reference to drawings. In this specification, various descriptions are presented to provide appreciation of the present disclosure. However, it will be apparent that these embodiments may be implemented without the specific descriptions set forth herein.

The component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “or” and “and/or” used in this specification designates and includes all available combinations of one or more items among enumerated related items.

Further, it should be appreciated that the term “comprise/include” and/or “comprising/including” means presence of corresponding features and/or components. However, it should be appreciated that the term “comprises/includes” and/or “comprising/including” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

And, the term “at least one of A or B” should be interpreted to mean “a case including only A”, “a case including only B”, and “a case in which A and B are combined”.

In the present disclosure terms represented by N-th such as first, second, or third are used for distinguishing at least one entity. For example, entities expressed as first and second may be the same as each other or different from each other.

In the present disclosure, an artificial intelligence model may refer to a program or a set of functions designed with a mathematical or statistical structure to automatically perform tasks such as prediction, classification, generation, and/or inference for a given input by learning patterns from data. An artificial intelligence model can be constructed by modeling the relationship between an input and an output in the form of a function. A specific example of an artificial intelligence model will be described later with reference to FIG. 2.

In the present disclosure, the performance of an artificial intelligence model may encompass the accuracy, efficiency, resource usage, inference speed, model lightweighting, and/or inference latency of the artificial intelligence model. In an embodiment, performance may encompass the performance of the model itself and/or the performance when the model is executed on a platform. In an embodiment, performance optimization may refer to activities and/or operations for improving or enhancing performance. For example, performance optimization may encompass compression, graph optimization, and/or quantization of an artificial intelligence model. For example, performance optimization may refer to changing or transforming at least a part of a model to improve such performance. For example, performance optimization may refer to changing, modifying or transforming at least one operator of a model to improve such performance For example, performance optimization may include the optimization of accuracy, which indicates how well the prediction results (e.g., inference results) of the model match the actual correct answers. For example, performance optimization may include transforming the model so that it produces the same or better results using less time or fewer computational resources.

In the present disclosure, compression of a model may refer to a process or algorithm that reduces the storage space occupied by an artificial intelligence model and improves computational efficiency, by reconfiguring or reducing the structure or parameters of the artificial intelligence model or of a group divided from the artificial intelligence model. For example, compression algorithms may include a pruning algorithm that removes unimportant weights or neurons, a quantization algorithm that converts floating-point weights to lower-precision integers, a knowledge distillation algorithm that trains a lightweighted student model to mimic the output of a large-scale teacher model, and the like.

In the present disclosure, graph optimization may refer to a process or algorithm that improves the inference performance of an artificial intelligence model by transforming, changing or modifying the computation graph of the artificial intelligence model. For example, a computation graph can represent the operational flow of a model with nodes (operations) and edges (data flow). Graph optimization can modify this computation graph to allow an artificial intelligence model to operate on a specific platform and/or to allow the artificial intelligence model to be executed more efficiently and quickly when executed (on the specific platform).

In the present disclosure, quantization may refer to a process or algorithm that changes or transforms the format of inputs, weights and/or activations of an artificial intelligence model. For example, quantization can convert the format of inputs, weights and/or activations of an artificial intelligence model to a lower bit-count integer or fixed-point format. For example, quantization may refer to an optimization technique that reduces memory usage and improves computation speed during the inference of an artificial intelligence model by changing floating-point (e.g., 32-bit float) values to integers (e.g., 8-bit int).

In the present disclosure, a model optimization tool may refer to a program or software that is applied to or executed on an artificial intelligence model for model optimization and/or model change. For example, a model optimization tool may include a trainer for training a model, a compressor for compressing a model, a graph optimizer for graph optimization of a model, a quantizer for quantizing a model, and/or a simulator for simulating expected execution results for a model without executing the model on a platform. In an embodiment, a model optimization tool may be used interchangeably with modules for transforming at least a part of a model, such as a core module, a model converter, and/or a model optimizer.

In the present disclosure, a platform may include a hardware on which an artificial intelligence model is to be executed and/or a compiler that connects the artificial intelligence model with the hardware. In an embodiment, a platform may be referred to as a deployment target, a system configuration, a runtime environment, an inference platform and/or an execution environment where an artificial intelligence model can be executed.

In the present disclosure, a transformation scenario may refer to a set of one or more model optimization tools. In an embodiment, each of a plurality of transformation scenarios may identify a combination of model optimization tools to be executed on an artificial intelligence model. In an embodiment, a transformation scenario may indicate model optimization tools and their application order or execution order. In an embodiment, a transformation scenario may indicate the execution order, number of executions, functions, and parameters of model optimization tools. In an embodiment, a transformation scenario may indicate a predetermined execution order to allow for the sequential execution of model optimization tools. In an embodiment, within a single transformation scenario, a plurality of model optimization tools may be arranged according to an execution order. In an embodiment, within a single transformation scenario, a plurality of model optimization tools are arranged according to an execution order, and the execution parameters of each of the model optimization tools may be defined. In an embodiment, a transformation scenario may identify a second combination of model optimization tools for a first combination of an artificial intelligence model and a platform. For example, a transformation scenario may identify what the combination of model optimization tools is according to the combination of an artificial intelligence model and a platform. For example, a transformation scenario may identify, for a combination of an artificial intelligence model, a hardware, and a compiler, the order in which the optimization modules are executed on the artificial intelligence model. For example, a transformation scenario may indicate a execution performance prediction value for a combination of the artificial intelligence model, a hardware, and a compiler, when optimization modules are executed on the artificial intelligence model. For example, a transformation scenario may identify, for a combination of an artificial intelligence model, a hardware, and a compiler, identification information of model optimization tools to be applied to the artificial intelligence model and optimization parameters used in at least one of the model optimization tools.

In the present disclosure, a scenario database (DataBase) may refer to a storage or a storage management program for storing, managing, and updating a plurality of transformation scenarios. In an embodiment, a plurality of transformation scenarios are stored in the scenario database (DB). The scenario DB may refer to a database that is searched and used to recommend the execution order of model optimization tools and the parameters of the model optimization tools according to an artificial intelligence model, a platform (e.g., a combination of a hardware and a compiler), and/or user requirements. For example, the scenario DB can manage combinations of model optimization tools for combinations of artificial intelligence models and platforms in a table-like structure.

In the present disclosure, the intermediate representation structure may refer to a standardized representation format used at an intermediate stage to optimize the computation graph or structure of a model for a specific execution environment or platform. In the present disclosure, the intermediate representation structure may be composed of a graph corresponding to an artificial intelligence model, a module representing a layer (or operator) that is dependently defined for a framework, and nodes representing the minimum unit of operators that constitute the module. In an embodiment, the intermediate representation structure may be configured such that all nodes within the intermediate representation structure (or constituting the artificial intelligence model) are included in any one module. In an embodiment, the intermediate representation structure may be configured such that all nodes within the intermediate representation structure are included in one or more modules. In an embodiment, the intermediate representation structure in the present disclosure may take the form of a graph. For example, the graph related to the intermediate representation structure in the present disclosure may refer to the result of abstracting an artificial intelligence model based on the connection relationship of modules, nodes, and/or tensors. The intermediate representation structure in the present disclosure may refer to an intermediate structure or a temporary structure for changing an artificial intelligence model for execution in various frameworks and/or on various platforms. The intermediate representation structure in the present disclosure may include a graph structure. The intermediate representation structure may be generated such that framework-independent nodes and modules, which are sets of nodes, have a hierarchical structure or a dependency relationship. The intermediate representation structure of the present disclosure may be configured to include nodes corresponding to framework-independent atomic operators, framework-dependent modules, and a tensor that connects the nodes and/or connects the modules. A tensor is a data structure used to represent the input, output, weights, intermediate calculation values, and/or quantization values of an artificial intelligence model. For example, a tensor may have a multi-dimensional array structure. For example, a tensor may have reference information for the transformation or optimization of an artificial intelligence model. For example, a tensor may be stored in an edge connecting nodes, and/or a tensor may be located in an edge connecting modules. For example, a tensor may be located at the input to a module or node, and/or a tensor may be located at the output from a module or node. The intermediate representation structure in the present disclosure may, for example, include a Static Graph of a deep learning framework such as TensorFlow or Onnx, and/or may include a Dynamic Graph in the form of an Eager execution mode of a deep learning framework such as PyTorch. For example, the intermediate representation structure may be generated by receiving an artificial intelligence model in the form of a Static Graph, may be generated by receiving an artificial intelligence model in the form of a Dynamic Graph, and/or may also be generated by receiving an artificial intelligence model to which model optimization tool(s) have been applied. The intermediate representation structure in the present disclosure may refer to a logical structure for expressing the function of an artificial intelligence model. The intermediate representation structure in the present disclosure may include a combination of nodes corresponding to the minimum unit of atomic operators that are universally applicable to a plurality of frameworks. For example, if the frameworks of artificial intelligence models that perform the same operation are different, different modules are included in the intermediate representation structure, and even if the frameworks of artificial intelligence models that perform the same operation are different, the same nodes may be included in the intermediate representation structure.

Within the intermediate representation structure in the present disclosure, a plurality of abstraction levels may be represented. For example, a module within the intermediate representation structure may refer to a component of a first abstraction level (e.g., a high-level abstraction) that represents an artificial intelligence model in units of inference functions, and a node within the intermediate representation structure may refer to a component of a second abstraction level (e.g., a low-level abstraction) that represents the artificial intelligence model in units of operators or operational units that implement the inference function of the artificial intelligence model. For example, a module within the intermediate representation structure is a component abstracted in units of functional blocks defined to be in charge of a specific sub-function of the entire inference process of an artificial intelligence model. For example, a node within the intermediate representation structure is a component abstracted in units of individual operators used to implement a sub-function of an artificial intelligence model.

In an embodiment, the abstraction level corresponding to a module may be higher than the abstraction level corresponding to a node. In an embodiment, the intermediate representation structure may be configured through a combination of components having mutually different abstraction levels. In an embodiment, the model optimization tools of the computing device 100 may hierarchically abstract an artificial intelligence model using modules and nodes through the intermediate representation structure according to a target transformation scenario. In an embodiment, the model optimization tools of the computing device 100 may generate an intermediate representation structure by abstracting an artificial intelligence model to a low level. Model optimization tools are executed on the intermediate representation structure to which the low-level abstraction has been applied, and an optimized or transformed (target) artificial intelligence model may be generated by abstracting the intermediate representation structure on which the model optimization tools have been executed to a high level.

The abstraction level in the present disclosure may refer to the degree to which a component constituting an artificial intelligence model is expressed as a higher-level concept structurally or semantically. The abstraction level in the present disclosure may refer to the degree to which a component of an artificial intelligence model is expressed as an operational unit or an operational block. The abstraction level in the present disclosure may refer to the degree or scope of grouping the components of a model into logical units. The abstraction level in the present disclosure may refer to an indicator for defining whether the representation method of an artificial intelligence model is a conceptual method (e.g., source code that is easy for humans to understand) or a concrete method (e.g., machine language that is easy for a machine to understand and execute). For example, the abstraction level may represent an indicator of how concrete (e.g., low-level) or general or conceptual (e.g., high-level) the method of representing or implementing an artificial intelligence model is.

For example, the higher the abstraction level, the greater the degree to which it is expressed as a higher-level concept. For example, a high-level abstraction may refer to conceptualizing or defining the components of an artificial intelligence model in terms of the conceptual or functional aspects of the artificial intelligence model. For example, a low-level abstraction may refer to conceptualizing or defining the components of an artificial intelligence model in terms of the implementation of the artificial intelligence model or in terms of operators. For example, a high-level abstraction may have a larger grouping size in terms of the grouping size of the components of an artificial intelligence model compared to a low-level abstraction. In an embodiment, nodes defined according to a relatively low-level abstraction may constitute or abstract a module or a graph corresponding to a relatively high-level abstraction.

In an additional embodiment, a low abstraction level refers to a form that can be directly executed by hardware, such as machine language, and a high abstraction level may refer to a conceptual representation that is easy for humans to understand, such as a source code or an algorithm design diagram. As an additional example, the abstraction level may be expressed in a plurality of levels, such as a low abstraction level (e.g., binary code and assembly code), an intermediate abstraction level (e.g., source code written in a programming language such as Python, C++, etc.), and a high abstraction level (e.g., a mathematical model, pseudocode of an algorithm, and a block diagram). For example, a compiler can lower the abstraction level of the artificial intelligence model by transforming human-readable source code into low-level machine code, or binary code, which the computer's hardware can execute.

A technique according to an embodiment of the present disclosure can efficiently achieve the transformation and/or optimization of an artificial intelligence model by varying the abstraction level of the artificial intelligence model. A technique according to an embodiment of the present disclosure can efficiently achieve the transformation and/or optimization of an artificial intelligence model by combining both a low-level abstraction and a high-level abstraction for the artificial intelligence model. A technique according to an embodiment of the present disclosure can efficiently achieve the transformation and/or optimization of an artificial intelligence model in a manner of generating an intermediate representation structure of a second abstraction level by applying a low-level abstraction to the artificial intelligence model and generating an artificial intelligence model of a first abstraction level by applying a high-level abstraction to the intermediate representation structure.

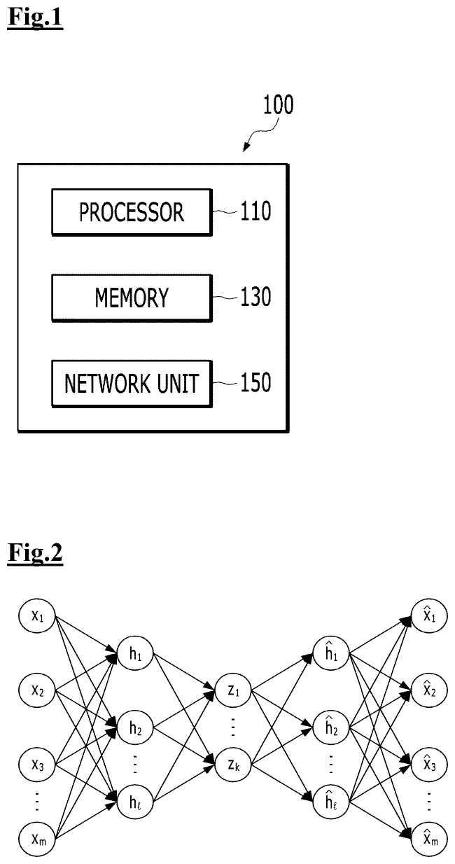

A configuration of the computing device 100 illustrated in FIG. 1 is only an example illustrated through simplification. In an exemplary embodiment of the present disclosure, the computing device 100 may include other components for performing a computing configuration of the computing device 100 and only some of the disclosed components may constitute the computing device 100.

The computing device 100, according to some embodiments of the present disclosure, may be a device for transforming artificial intelligence model for performance optimization of artificial intelligence model. The computing device 100 may include any type of server and/or any type of device. The server may include, for example, any type of computer system or computer device, such as a microprocessor, mainframe computer, digital processor, portable device, device controller, web server, application server, or database server.

In one embodiment, the computing device 100 may include a user device. For example, the computing device 100 may correspond to a user device that receives data resources generated by any server and performs additional information processing. The user device may include, but is not limited to, a personal computer, notebook, mobile terminal, smart phone, tablet PC, or other device owned by the user.

The computing device 100 may include a processor 110, a memory 130, and a network unit 150.

The processor 110 may be composed of one or more cores and may include a processor for performing operations related to data processing, such as a central processing unit (CPU), a general-purpose graphics processing unit (GPGPU), a digital signal processor (DSP), a tensor processing unit (TPU), or a neural processing unit (NPU). The processor 110 may perform data processing for transforming artificial intelligence model for performance optimization of artificial intelligence model according to an embodiment of the present disclosure, by reading a computer program stored in the memory 130. In other words, a computer program stored in a computer-readable storage medium (e.g., the memory 130) may cause one or more processors (e.g., the processor 110) to perform operations for transforming artificial intelligence model for performance optimization of artificial intelligence model, in accordance with an embodiment of the present disclosure. In addition, the processor 110 may implement any component for performing data processing to transform artificial intelligence model for performance optimization of artificial intelligence model, according to an embodiment of the present disclosure.

According to an exemplary embodiment of the present disclosure, the processor 110 may also perform a computation for learning a neural network. For example, the processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, DSP, TPU, and NPU of the processor 110 may process learning of a network function. For example, both the CPU and the GPGPU may process the learning of the network function and data classification using the network function. Further, in an exemplary embodiment of the present disclosure, processors of the plurality of computing devices may be used together to process the learning of the network function and the data classification using the network function.

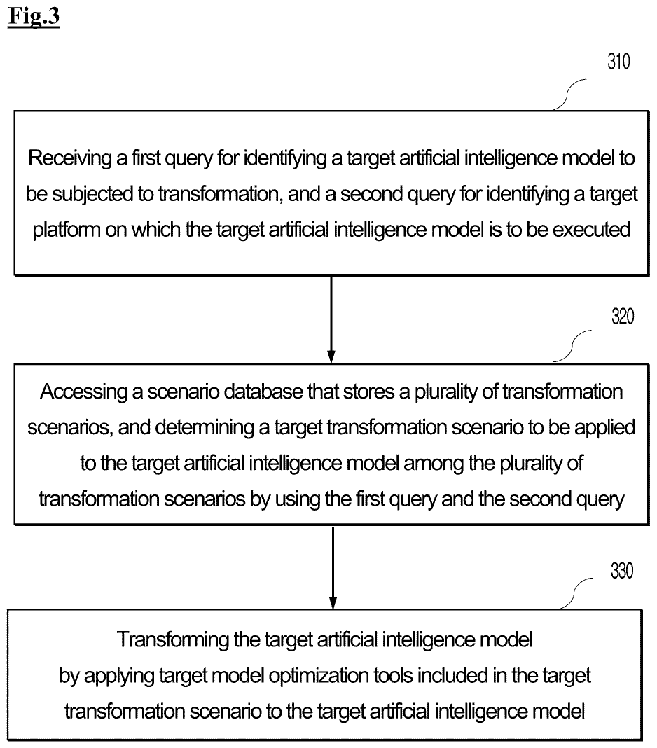

The processor 110 may generally control the overall operation of the computing device 100. For example, the processor 110 may perform the steps included in the flowchart of FIG. 3, which will be described below. By processing signals, data, or information that are input or output through the components included in the computing device 100 or by driving the application program stored in the memory 130, the processor 110 may provide or process appropriate information or functions for the user.

In an embodiment, the computing device 100 may include a System on Chip (SoC). For example, the computing device 100 may include a single chip on which the processor 110, the memory 130, and the network unit 150 shown in FIG. 1 are all mounted. In this case, the SoC may further include any modules for implementing the operations of the computing device 100, such as an I/O interface, a Power Management IC (PMIC), a security module, etc. Meanwhile, it will be apparent to one of ordinary skill in the art that the SoC can be referred to as a processor. Therefore, in such an embodiment, the operations performed by the processor 110 in the present disclosure should be interpreted as being performable by the SoC.

In an embodiment of the present disclosure, the memory 130 may store any type of information generated or determined by the processor 110 and/or any type of information received by the network unit 150. In an embodiment, the memory 130 may store information regarding an artificial intelligence model, information regarding a platform, information regarding a transformation scenario, a scenario DB, and/or information regarding a model optimization tool, and the like.

In an embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and/or an optical disk. The computing device 100 may operate in connection with a web storage performing a storing function of the memory 130 on the Internet. The memory 130 may include an embedded memory mounted inside the processor 110 and/or a memory mounted outside the processor 110 within the computing device 100. The above description of the memory is just an example and the memory 130 used in the present disclosure is not limited thereto. The memory 130 may be operated by the processor 110.

According to an embodiment of the present disclosure, the network unit 150 may implement any type of wired or wireless communication network capable of transmitting and receiving various types of data and signals. The technologies described in the present specification may be implemented not only through the networks mentioned above, but also through other types of networks.

FIG. 2 illustrates a network function according to an exemplary embodiment of the present disclosure.

Throughout the present disclosure, the artificial intelligence model, the artificial intelligence based model, the operation model, the machine learning model, the deep learning model, the neural network, the network function, and the neural network may be used interchangeably to refer to the same concept.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links. The node in FIG. 2 is used to mean a neuron within the artificial intelligence model (i.e., a neural network model), and the node in the intermediate representation structure is used to represent an atomic operator. The node in the intermediate representation structure is used to constitute a module and may have a different meaning from the node corresponding to a neuron in a neural network. A set of nodes in FIG. 2 may represent a layer or an operator, whereas the node in the intermediate representation structure corresponds to an atomic operator that cannot be decomposed.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes decreases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in the artificial intelligence based model of the present disclosure may be learned in at least one scheme of supervised learning, unsupervised learning, semi supervised learning, or reinforcement learning, federated learning for distributed deep learning, and incremental learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data.

As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an embodiment of the present disclosure, a computer-readable medium storing a data structure is disclosed. The above-described data structure may be stored in the memory 130 of the present disclosure, executed by the processor 110, and transmitted or received by the network unit 150.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

An artificial intelligence-based model according to an embodiment of the present disclosure may include a Large Language Model (LLM). In the present disclosure, a Large Language Model may refer to an artificial intelligence-based model trained using a vast amount of training data to perform Natural Language Processing. A Large Language Model may include a transformer, an encoder-type model of a transformer, and/or a decoder-type model of a transformer. An encoder-type model of a transformer may correspond to an artificial intelligence model that uses the encoder structure of a transformer. A decoder-type model of a transformer may correspond to an artificial intelligence model that uses the decoder structure of a transformer. As an example, the artificial intelligence-based model of the present disclosure may include a GPT-family Large Language Model, a Bidirectional Encoder Representations from Transformers (BERT)-family Large Language Model, and the like.

In an embodiment, a transformer may be composed of an encoder that encodes input data and a decoder that decodes the encoded data. A transformer may have a structure that takes a series of input data as input and outputs a series of output data through encoding and decoding steps. In an embodiment, the series of input data may be processed into a form that a transformer can compute. The process of processing the series of input data into a computable form for the transformer may include a tokenizing process and an embedding process. The tokenizing process may refer to a process of dividing a series of input data into tokens of a certain unit. For example, the certain unit may include a word unit. The embedding process may refer to a process of converting at least one token, tokenized from the series of input data, into an embedding vector.

In an embodiment, a transformer can obtain an embedding vector to be input into an encoder by summing a token embedding vector, which embeds at least one token corresponding to a series of input data, a segment embedding vector that distinguishes the sentence containing the token for each token, and a position embedding vector that reflects the position of the token. Encoder-type models and decoder-type models of a transformer may also perform the same method to obtain an embedding vector.

In an embodiment, for a transformer to encode and decode a series of input data, the encoder and decoder within the transformer may utilize an attention algorithm. The attention algorithm may refer to an algorithm that, for a given Query, calculates a similarity by applying a softmax function to an attention score obtained by matrix-multiplying the Query with a Key, and then calculates an attention value for the Query by matrix-multiplying the calculated similarity with a Value.

In an embodiment, a self-attention algorithm may refer to an attention algorithm that uses a Query, Key, and Value generated by respectively multiplying the same embedding vector by a query weight, a key weight, and a value weight. A cross-attention algorithm may refer to an attention algorithm that uses a Query generated by multiplying a first embedding vector by a query weight, and a Key and a Value generated by respectively multiplying a second embedding vector by a key weight and a value weight. The query weight, key weight, and value weight may be trainable parameters that are updated through the learning process of the Large Language Model.

In an embodiment, the encoder of a transformer may include an embedding layer, a self-attention layer that applies a self-attention algorithm to an embedding vector, a normalization layer, and a Feed Forward Neural Network (FFN). Furthermore, the encoder may have a form in which N unit structures, each comprising a self-attention layer, a normalization layer, and a feed-forward neural network, are connected. The decoder of a transformer may include an embedding layer, a masked self-attention layer, a normalization layer, a cross-attention layer that applies a cross-attention algorithm, and a feed-forward neural network. Furthermore, the decoder may have a form in which N unit structures, each comprising a masked self-attention layer, a normalization layer, a cross-attention layer, and a feed-forward neural network, are connected. The masked self-attention layer may correspond to a layer that calculates an attention value for each of the sequences in which words are sequentially included, for a plurality of words included in a series of input data.

A transformer may include not only an encoder and a decoder but also additional components such as a linear layer, a softmax layer, etc. Encoder-family models and decoder-family models of a transformer may also respectively include not only an encoder and a decoder but also the aforementioned additional components. A method for constructing a transformer using an attention algorithm may include the method disclosed in Vaswani et al., “Attention Is All You Need,” 2017 NIPS, which is incorporated herein by reference.

In an embodiment, an attention layer such as a self-attention layer, a masked self-attention layer, or a cross-attention layer may correspond to a multi-head attention layer that includes a plurality of attention layers in parallel. The multi-head attention layer can concatenate the attention values output from each of the plurality of attention layers, and matrix-multiply the concatenated matrix with an output weight to output an output attention value. The output attention value output from the multi-head attention layer may have the same size as the attention value output from a single attention layer.

In an embodiment, a transformer may be trained through a Masked Language Model (MLM) process, a Next Sentence Prediction (NSP) process, and the like. The MLM process may refer to a learning process that predicts a masked word through a series of training data in which some words are masked. The NSP process may refer to a learning process that determines whether two sentences are connected in a series of training data that includes two arbitrary sentences.

In an embodiment, a Large Language Model can process not only natural language text but also various data formats such as image data, audio data, and video data. A Large Language Model can embed data to convert data with various formats into a series of computable data. A Large Language Model can process additional data that represents the relative positional relationship or topological relationship between a series of input data. Alternatively, a series of input data can be embedded by additionally reflecting vectors that represent the relative positional relationship or topological relationship between the input data. As an example, the relative positional relationship between a series of input data may include, but is not limited to, the word order within a natural language sentence, the relative positional relationship of each divided image, the time sequence of a divided audio waveform, etc. The process of adding information that represents the relative positional or topological relationship between a series of input data may be referred to as positional encoding.

An example of a Large Language Model that processes image data (Vision Transformer, ViT) is disclosed in Dosovitskiy, et al., “AN IMAGE IS WORTH 16×16 WORDS: TRANSFORMERS FOR IMAGE RECOGNITION AT SCALE,” and this document is incorporated herein by reference.

An artificial intelligence model according to an embodiment of the present disclosure may include a multi-modal Large Language Model. A multi-modal Large Language Model may refer to a Large Language Model that can understand and process the relationship between mutually different data formats, such as natural language text data, image data, audio data, and video data. A multi-modal language model may include a plurality of encoders that encode input data corresponding to each data format. The multi-modal language model can be trained, through training data that includes data of mutually different formats, to calculate the similarity between embedding vectors encoded from the encoder of each data format, such that the similarity for the same pairs is calculated to be higher, and the similarity for different pairs is calculated to be lower.

An example of a multi-modal Large Language Model that understands and processes the relationship between image data and natural language text data (Contrastive Language-Image Pre-training, CLIP) is disclosed in Alec Radford, et al., “LEARNING TRANSFERABLE VISUAL MODELS FROM NATURAL LANGUAGE SUPERVISION,” and this document is incorporated herein by reference.

FIG. 3 is a flowchart illustrating a method for transforming an artificial intelligence model for performance optimization of the artificial intelligence model according to an embodiment of the present disclosure.

The flowchart shown in FIG. 3 is merely an exemplary sequence, and some steps may be omitted, the order may be changed, or other steps may be added within a scope apparent to one of ordinary skill in the art.

In an embodiment, the computing device 100 may receive a first query for identifying a target artificial intelligence model that is a target of transformation, and a second query for identifying a target platform on which the target artificial intelligence model is to be executed (310).

In the present disclosure, a query may refer to a request generated by a user or a user terminal. The first query, the second query, and/or a third query may refer to a logical distinction for a user request or may refer to physically separate queries.

In an embodiment, the target artificial intelligence model may refer to an artificial intelligence model that is the object of performance optimization. For example, the target artificial intelligence model is an artificial intelligence model received from a user and may be transformed or changed by target model optimization tools according to a technique according to an embodiment of the present disclosure. For example, the target artificial intelligence model may be included in the first query from a user terminal. For example, the target artificial intelligence model may include identification information of the artificial intelligence model, executable file information of the artificial intelligence model, training dataset information of the artificial intelligence model, execution environment information of the artificial intelligence model, and/or framework information of the artificial intelligence model.

In an embodiment, the target platform may include a hardware and/or a compiler on which the target artificial intelligence model is to be executed. In an embodiment, the target platform may represent a combination of a hardware and a compiler on which the target artificial intelligence model is to be executed. In an embodiment, the target platform may be included in the second query from a user or a user terminal. For example, information regarding the hardware included in the target platform may include, for instance, information regarding a CPU, GPU, NPU, and FPGA, etc. Information regarding the hardware may refer to any form of information for identifying the hardware on which the artificial intelligence model can be executed. For example, information regarding the hardware may include information related to the physical components of a system and their characteristics, structure, performance, compatibility, and the like. For example, information regarding the hardware may include at least one of identification information of the hardware, information on supportable frameworks, information on supportable data types, information on supportable operators, or information on supportable granularity. As another example, information regarding the hardware may include a hardware constraint. The hardware constraint may include at least one of whether each of the data types of an operator is supported, whether hardware operational acceleration for an operator is supported, or whether speed is improved for each of the data types of an operator. For example, a data type may be the type of values that can be used when storing and processing data in a hardware or programming language, and the method of their representation. A data type may be a type of data classified according to the method of data storage and operation. For example, a data type may include an integer type, a real number type, a character type, and the like. A hardware supports operations for specific data types, and each data type may have a different memory size and representation range. For example, information regarding the compiler included in the target platform may refer to any form of information for identifying an entity that connects the artificial intelligence model and the hardware. For example, a platform may be identified and/or managed in units of a combination of a hardware and a compiler.

In an embodiment, a query from a user or a user terminal may be input to the computing device. The corresponding query may include a first query for identifying a target artificial intelligence model and a second query for identifying a target platform.

In an embodiment, a third query including the first query, the second query, and a target performance value that serves as a criterion for the transformation of the target artificial intelligence model may be received from a user or a user terminal. This first query, second query, and third query may be utilized as conditions and/or criteria for determining a target transformation scenario from among a plurality of transformation scenarios in the scenario DB.

In an embodiment, the computing device 100 may access a scenario database that stores a plurality of transformation scenarios, and may determine a target transformation scenario to be applied to the target artificial intelligence model from among the plurality of transformation scenarios by using the first query and the second query (320).

In an embodiment, each of the plurality of transformation scenarios stored in the scenario database may identify a combination of model optimization tools to be executed on an artificial intelligence model. Each of the plurality of transformation scenarios stored in the scenario DB may identify a second combination of model optimization tools for a first combination of an artificial intelligence model and a platform. For example, a combination of an artificial intelligence model named A, a platform named B, and model optimization tools arranged in the order of C, D, E, and F may be included in a single transformation scenario. The scenario DB can manage the combination of model optimization tools for the combination of an artificial intelligence model and a platform, for example, in a table-like structure. For example, each of the plurality of transformation scenarios may identify, for a first combination of an artificial intelligence model and a platform, an order in which the model optimization tools are applied to the artificial intelligence model.

In an embodiment, the computing device 100 may access the scenario DB and input a combination of the first query and the second query into the scenario DB. The computing device 100 may receive, obtain, or determine a target transformation scenario that matches the combination of the first query and the second query from among the plurality of transformation scenarios. As the computing device 100 obtains the target transformation scenario that matches the combination of the first query and the second query, it may receive, obtain, and/or determine identification information of model optimization tools and/or the execution order of the model optimization tools stored in the target transformation scenario. As a non-limiting example, the order in which the model optimization tools identified in each of the plurality of transformation scenarios are applied to an artificial intelligence model may be determined based on a performance change prediction value by each of the model optimization tools and a constraint according to the platform.

In an embodiment, the scenario DB may include identification information of an artificial intelligence model or identification information of a block of an artificial intelligence model, identification information of a model optimization tool or identification information of an optimization scheme, and performance information related to the artificial intelligence model to which the model optimization tool or the optimization scheme has been applied. The scenario DB may represent the aforementioned information in a table structure.

In an embodiment, the scenario DB may store and manage a plurality of transformation scenarios. Each of the plurality of transformation scenarios may indicate a performance prediction value for a first combination of an artificial intelligence model and a platform, when the model optimization tools are applied to the artificial intelligence model. For example, the performance prediction value may refer to the expected execution performance of the artificial intelligence model when the artificial intelligence model to which the model optimization tools have been applied is executed on the platform. For example, the performance prediction value may include at least one of an accuracy of the artificial intelligence model, an inference speed of the artificial intelligence model, and a degree of lightweighting of the artificial intelligence model. For example, the scenario DB may manage a plurality of transformation scenarios and the expected execution performance according to the scenarios in the form of a table structure.

In an embodiment, the model optimization tools may include a trainer, a compressor, a graph optimizer, a quantizer, and/or a simulator. The model optimization tools may include various types of trainers, various types of compressors, various types of graph optimizers, various types of quantizers, and/or various types of simulators. The interconnection relationship between these model optimization tools may be managed as a transformation scenario. For example, a trainer can generate a training result of an artificial intelligence model. For example, a compressor can lightweight an artificial intelligence model, such as by filter decomposition and/or pruning. The compressor can measure the locations where a lightweighting technique is applicable and perform compression based on platform information using the measured locations. For example, a quantizer can perform quantization of an artificial intelligence model based on the data types supported by the hardware and/or compiler. For example, an Advanced quantizer can perform quantization of a model through a quantization technique that operates in an Eager execution mode. For example, a graph optimizer can remove operators not required by the hardware and/or compiler from the model, change an unsupported operator to a supported operator, change an unsupported operator to a combination of supported operators, and/or change a supported operator to an operator for more efficient operation. For example, a simulator can generate an expected execution result for when an artificial intelligence model is executed on a platform. The simulator can generate an expected execution result of an artificial intelligence model by simulating a runtime that operates on the hardware. For example, these model optimization tools may be executed or applied on an intermediate representation structure to be described later. Accordingly, transformation of a model and simulation of the model may be possible without directly executing the actual model on the actual hardware.

In an embodiment, the target platform may include at least one of a hardware on which the target artificial intelligence model is to be executed, a compiler for connecting the artificial intelligence model to the hardware, and a runtime indicating an environment of the hardware on which the artificial intelligence model is to be executed. For example, information about the target platform may be received from a user or a user terminal.

In an additional embodiment, the computing device 100 may automatically generate recommendation information for candidate platforms on which the target artificial intelligence model can be executed, from the first query including the target artificial intelligence model. In response to a user selection input on this recommendation information, a target platform, which is the execution target of the target artificial intelligence model, may be determined from among the candidate platforms.

In an embodiment, the computing device 100 may access the scenario DB and query the scenario DB with the first query and the second query. The computing device 100 may receive or obtain a target transformation scenario from the scenario DB in response to the query. For example, the computing device 100 may calculate a model similarity between the target artificial intelligence model and a plurality of candidate artificial intelligence models stored in the scenario DB by using the first query. For example, the model similarity may be determined using identification information of operators (or layers) included in the model and/or connection information of the operators. For example, the model similarity may be calculated, for each of the target artificial intelligence model and the candidate artificial intelligence models stored in the scenario DB, in units of groups of operators (e.g., blocks) included in the model. For example, the computing device 100 may transform an artificial intelligence model into a graph structure and quantitatively measure the model similarity between two artificial intelligence models by using, as factors, patterns of nodes, identification information of nodes, the number of nodes, identification information of modules, the number of modules, and/or patterns of modules within the graph structure. For example, the computing device 100 may calculate the model similarity by measuring sub-similarities between a plurality of artificial intelligence models in units of operators or blocks constituting the artificial intelligence models and combining the measured sub-similarities. For example, the computing device 100 may measure the similarity between artificial intelligence models by using a cosine similarity on the output values for the same input, because the lightweighting performance may differ if the weights are different, even if the artificial intelligence models include the same blocks or the same operators, and this similarity may be utilized in the model similarity measurement. In an embodiment, the computing device 100 may preemptively use the model similarity to determine the artificial intelligence model most similar to the target artificial intelligence model within the scenario DB, and may search on the scenario DB for a scenario that maps to the hardware, compiler, user environment, and target performance for the determined model. In an embodiment, in a situation where the model similarity is lower than a similarity threshold, the computing device 100 may determine that it cannot find a model similar to the target artificial intelligence model in the scenario DB and may perform a transformation scenario preparation process for storing the target artificial intelligence model as a new model in the scenario DB. In such an embodiment, the computing device 100 may determine whether to change to the transformation scenario preparation process or maintain the transformation scenario execution process, based on a result of the comparison of the model similarity between the target artificial intelligence model included in the first query and the models on the scenario DB.

In an embodiment, the computing device 100 may determine the target transformation scenario to be applied to the target artificial intelligence model from among the plurality of transformation scenarios stored in the scenario DB, by using the model similarity, the target platform in the second query, and/or a target performance value specified by the user as conditions. The computing device 100 may perform a search within the scenario DB by using the conditions including the aforementioned factors as a filtering criterion. For example, the computing device 100 may perform a search on the scenario DB by using a combination of the model similarity, the target platform, and the target performance value as a filtering criterion. Through such a search according to the filtering criterion, a target transformation scenario corresponding to the user's intent can be efficiently obtained or generated.

In an embodiment, the computing device 100 may determine a reference artificial intelligence model corresponding to the target artificial intelligence model from among the candidate models stored in the scenario DB, based on the calculation result of the model similarity for each of the target artificial intelligence model and the candidate artificial intelligence models stored in the scenario DB. The computing device 100 may determine a scenario that is mapped to the target platform and the target performance value specified by the user as the target transformation scenario, based on the reference artificial intelligence model. For example, the computing device 100 may determine the reference artificial intelligence model with the highest similarity to the target artificial intelligence model from among the candidate artificial intelligence models, and may filter or sort a plurality of transformation scenarios including the reference artificial intelligence model within the scenario DB by utilizing the determined reference artificial intelligence model as a search criterion. The computing device 100 may determine the target transformation scenario that matches the combination of the first query and the second query from among the filtered transformation scenarios, by using the target platform and/or user requirements (e.g., target performance value, etc.) as an additional filtering condition.

In an embodiment, the computing device 100 may receive a target performance value in addition to the first query and the second query, and this target performance value may define a performance value that serves as a criterion for the transformation of the target artificial intelligence model. The computing device 100 may compare the target performance value with the performance prediction value of each of the transformation scenarios (or each of the model optimization tools) in the scenario DB and may determine the target transformation scenario to be applied to the target artificial intelligence model based on the result of the comparison. For example, the computing device 100 may search for and/or determine the target transformation scenario on the scenario DB, which is a relational DB with a table structure, in a resource-efficient manner, by using the identification information of the target artificial intelligence model included in the first query, the identification information of the target platform included in the second query, and the target performance value as search conditions. For example, the computing device 100 may compare the target performance value with each of the performance prediction values (of each of the transformation scenarios) stored in the scenario DB, and may perform a search according to the combination of the first query and the second query on the transformation scenarios that have passed a criterion based on the comparison. In this manner, the optimization method for the user's artificial intelligence model according to the conditions intended by the user can be automatically determined with efficient use of computing resources.

In an embodiment, the computing device 100 may measure the model similarity between a plurality of artificial intelligence models registered in the scenario DB and the target artificial intelligence model included in the first query. The model similarity may represent the similarity between combinations of components (e.g., operators (layers)) included in the model. A target scenario that is most similar to the criteria may be determined from among the plurality of transformation scenarios stored on the scenario DB, based on the model similarity, hardware information and compiler information included in the target platform, the user environment, and/or the target performance. For example, if the user environment is incapable of training or if no data exists, it may be determined that a trainer cannot be used, and transformation scenarios in which a trainer exists may be filtered out from among the transformation scenarios. For example, if the user environment is incapable of training or if no data exists, even if the execution mode of the target artificial intelligence model is determined to be the Eager execution mode, a transformation scenario that does not include an Advanced Compressor and/or an Advanced Quantizer may be determined as the target transformation scenario.

In an embodiment, the computing device 100 may vary the method of determining the target transformation scenario according to the execution scheme of the target artificial intelligence model included in the first query. For example, a correlation between the execution scheme, execution mode, or execution type of the target artificial intelligence model included in the first query and the determination method of the target transformation scenario may be automatically determined by the computing device 100. For example, the computing device 100 may determine, from the first query, the execution mode of the target artificial intelligence model as one of an eager execution mode and a graph execution mode, based on the execution scheme of the target artificial intelligence model. For example, the eager execution mode may refer to a scheme of executing operations in the artificial intelligence model without converting to a graph. For example, the graph execution mode may refer to a scheme of converting operations to a graph before the execution of the artificial intelligence model. Each of the artificial intelligence models has an execution mode defined for its execution. The computing device 100 may determine what the execution mode of the target artificial intelligence model is, by using the identification information of the target artificial intelligence model included in the first query and/or by parsing the target artificial intelligence model (e.g., analysis of identification information and connection structure of operators). For example, the computing device 100 may determine whether the corresponding target artificial intelligence model is in an Eager execution mode or a Graph execution mode by executing the target artificial intelligence model on a specific platform. For example, if it is confirmed that the target artificial intelligence model immediately executes an operator during its execution process, the computing device 100 may classify the target artificial intelligence model as being in an Eager execution mode. For example, if it is confirmed that the target artificial intelligence model adds an operator to a computation graph during its execution process and executes the computation graph all at once, the computing device 100 may classify the target artificial intelligence model as being in a Graph execution mode. In an additional example, the computing device 100 may classify the target artificial intelligence model as being in an Eager execution mode if it belongs to a first group of frameworks and in a Graph execution mode if it belongs to a second group of frameworks, by analyzing the framework of the target artificial intelligence model.

In an embodiment, the computing device 100 may determine filtered candidate transformation scenarios that include the determined execution mode from among the plurality of transformation scenarios stored in the scenario DB, by using the determined execution mode of the target artificial intelligence model as a filtering criterion. The computing device 100 may determine the target transformation scenario to be applied to the target artificial intelligence model from among the filtered candidate transformation scenarios. Since this method can reduce the search space of the scenario DB in the process of determining the target transformation scenario, a technical effect can be achieved in that the technique according to an embodiment of the present disclosure can determine the execution order of model optimization tools suitable for a user query while efficiently using computing resources.

In an embodiment, the computing device 100 may transform the target artificial intelligence model by applying target model optimization tools included in the target transformation scenario to the target artificial intelligence model (330).

In an embodiment, the computing device 100 may execute the model optimization tools on the target artificial intelligence model, by using the execution order and parameters of the model optimization tools on the obtained target transformation scenario.

In an embodiment, the computing device 100 may sequentially execute the model optimization tools on the target artificial intelligence model according to the execution order of the model optimization tools on the target transformation scenario. Depending on the implementation aspect, it may also be possible for the computing device 100 to execute them in parallel on the target artificial intelligence model for model optimization tools designated as capable of parallel execution on the target transformation scenario.

In an embodiment, the computing device 100 may generate an expected simulation result for when the target transformation scenario is applied to the target artificial intelligence model by using a simulator. In this manner, the utility of the determined target transformation scenario can be verified in a resource-efficient way through an expected simulation result, without performing the execution of the actual platform and model. As a non-limiting example, the computing device 100 may transform an artificial intelligence model into an intermediate representation structure composed of a hierarchical structure of nodes corresponding to atomic operators and modules composed of a set of nodes, and the simulator operates on the transformed intermediate representation structure, so that the expected execution performance of the artificial intelligence model can be derived without the artificial intelligence model being executed on a platform. As a non-limiting example, the computing device 100 may generate an intermediate representation structure that represents the target artificial intelligence model, which is the subject of simulation, with nodes corresponding to framework-independent atomic operators and modules dependent on the framework of the target artificial intelligence model. This intermediate representation structure may have a hierarchical structure in which one or more nodes constitute the module. As the framework-dependent module(s) of the intermediate representation structure are modified according to the target platform, a simulation of the target artificial intelligence model on the target platform can be performed. In this manner, the expected execution performance according to the combination of the target artificial intelligence model and the target platform when model optimization tools are applied to the target artificial intelligence model in the order according to the target transformation scenario can be verified. Accordingly, the utility of the model optimization tools can be verified.

In the present disclosure, the intermediate representation structure may refer to a standardized representation format used at an intermediate stage to optimize the computation graph or structure of a model for a specific execution environment or platform. In the present disclosure, the intermediate representation structure may be composed of a graph corresponding to an artificial intelligence model, a module representing a layer (or operator) that is dependently defined for a framework, and nodes representing the minimum unit of operators that constitute the module. In the present disclosure, the intermediate representation structure may refer to an intermediate structure or a temporary structure for changing an artificial intelligence model for execution in various frameworks and/or on various platforms. In the present disclosure, the intermediate representation structure may include a graph structure. The intermediate representation structure may be generated such that framework-independent nodes and modules which are sets of nodes, have a hierarchical structure or a dependency relationship. The intermediate representation structure of the present disclosure may be configured to include nodes corresponding to framework-independent atomic operators, framework-dependent modules, and a tensor that connects the nodes and/or connects the modules. A tensor is a data structure used to represent the input, output, weights, intermediate calculation values, and/or quantization values of an artificial intelligence model. For example, a tensor may have a multi-dimensional array structure. For example, a tensor may be located with reference information for the transformation or optimization of an artificial intelligence model. For example, a tensor may be stored in an edge connecting nodes, and/or a tensor may be located in an edge connecting modules. For example, a tensor may be located at the input to a module or node, and/or a tensor may be located at the output from a module or node. The intermediate representation structure in the present disclosure may, for example, include a Static Graph of a deep learning framework such as TensorFlow or Onnx, and/or may include a Dynamic Graph in the form of an Eager execution mode of a deep learning framework such as PyTorch. For example, the intermediate representation structure may be generated by receiving an artificial intelligence model in the form of a Static Graph, may be generated by receiving an artificial intelligence model in the form of a Dynamic Graph, and/or may also be generated by receiving an artificial intelligence model to which model optimization tool(s) have been applied. The intermediate representation structure in the present disclosure may refer to a logical structure for expressing the function of an artificial intelligence model. The intermediate representation structure in the present disclosure may include a combination of nodes corresponding to the minimum unit of atomic operators that are universally applicable to a plurality of frameworks. For example, if the frameworks of artificial intelligence models that perform the same operation are different, different modules are included in the intermediate representation structure, and even if the frameworks of artificial intelligence models that perform the same operation are different, the same nodes may be included in the intermediate representation structure.

In the present disclosure, a framework may refer to a set of libraries and tools for designing, building, training, evaluating, and deploying an artificial intelligence model. A framework may refer to software that enhances the efficiency and reproducibility of model development. A framework may refer to a development environment for building an artificial intelligence model. A framework may be used in a sense that encompasses the execution environment and/or runtime of an artificial intelligence model. A framework allows for the definition and execution of the structure and operation of an artificial intelligence model. For example, a framework may be exemplified by TensorFlow, PyTorch, ONNX, TensorFlow Lite, TensorRT, JAX, and MXNet. These various frameworks may each have different operator structures and operator processing methods.

In an embodiment, the computing device 100 may transform the aforementioned target artificial intelligence model into the aforementioned intermediate representation structure, and may execute or apply the target model optimization tools on the intermediate representation structure. As the target model optimization tools are executed or applied, the module, node, and/or tensor (e.g., a tensor is a data structure connecting modules or connecting nodes and represents the input/output, activation function, weights, and/or bias of a module or node) within the intermediate representation structure may be changed. A simulation result may be generated by a simulator using the changed intermediate representation structure.

In an embodiment, the computing device 100 may apply and/or execute the target model optimization tools included in the target transformation scenario on the target artificial intelligence model through a simulator according to the order specified in the target transformation scenario, without executing the transformed target artificial intelligence model on the target platform. This execution through a simulator may mean that the target model optimization tools are applied or executed on the intermediate representation structure corresponding to the combination of the target artificial intelligence model and the target platform. The computing device 100 may generate a performance verification result including an estimated inference simulation result for a case where the transformed target artificial intelligence model is executed on the target platform. The performance verification result may be utilized in the verification process of the target transformation scenario.

In an embodiment, the computing device 100 may compare the performance verification result of the transformed target artificial intelligence model with a performance prediction value mapped to the target transformation scenario. For example, the computing device 100 may compare the result simulated through the simulator with the performance prediction value stored in the scenario DB to verify if there is a difference between the actual performance of the target transformation scenario and the prediction value. The computing device 100 may determine whether to modify the target transformation scenario based on the result of the comparison. For example, if the difference value between the performance prediction value and the performance verification result obtained through the simulator exceeds a predetermined threshold difference (or if the performance is not better than the performance prediction value), the computing device 100 may determine to modify the target transformation scenario. In this case, the computing device 100 may change a parameter of at least one of the target model optimization tools included in the target transformation scenario. For example, changing the parameter may refer to changing the value of an optimization-related parameter (e.g., compression rate, compression ratio, compression method, and/or quantization method, etc.) mapped to the model optimization tools. The computing device 100 may perform a second transformation of the target artificial intelligence model, by applying the target model optimization tools including the changed parameter to the target artificial intelligence model before transformation. For instance, the target model optimization tools including the changed parameter can be applied to the target artificial intelligence model in its state prior to the transformation. Accordingly, a technical effect can be achieved in that the computing device 100 can achieve more efficient and more accurate optimization of an artificial intelligence model by modifying a transformation result that has not reached the performance prediction value on the scenario DB. For example, the second transformation is a transformation that follows a first transformation (i.e., a first optimization) that was simulated through a simulator, and may be applied to the target artificial intelligence model before the first transformation was made or applied. For example, the result according to the second transformation may also be simulated by a simulator in the aforementioned manner. If the simulation result for the second transformation satisfies a predetermined threshold criterion, the computing device 100 may update the scenario DB with the parameter value included in the second transformation. If the simulation result for the second transformation satisfies a predetermined threshold criterion (e.g., if it falls within the range of the expected performance value, or if it is not degraded compared to the expected performance value), the computing device 100 may update the parameter value of the target transformation scenario on the scenario DB with the parameter value included in the second transformation.

In an embodiment, it is assumed that according to the parameters of the compressor (e.g., compression ratio 10%) and the quantizer (e.g., Int8:Int16=1:9) included in the determined target transformation scenario, the performance verification result according to the first transformation was output as an accuracy decrease of 0.5% and an inference speed decrease of 3%. If the performance prediction value mapped to the target transformation scenario on the scenario DB is recorded as an accuracy decrease of 0.3% and an inference speed decrease of 3%, the computing device 100 may determine that the performance verification result according to the first transformation did not satisfy the threshold criterion, change at least one of the parameters of the compressor and/or the quantizer included in the target transformation scenario, and perform a second transformation of the target artificial intelligence model according to the target transformation scenario to which the changed parameter is applied. If the computing device 100 performs a simulation of the target artificial intelligence model on which the second transformation was performed and determines that the simulation result satisfies the criterion according to the performance prediction value, it may output the target artificial intelligence model transformed or optimized according to the second transformation. In this case, the target transformation scenario may be updated with the parameters defined by the second transformation. As the scenario DB is dynamically updated in this manner, a scenario DB composed of more robust and solid transformation scenarios can be generated and managed.

In an embodiment, because the scenario DB can be dynamically updated based on the performance measured through the simulator, the reliability and accuracy of the scenario DB can be improved.

In an embodiment, the computing device 100 may receive the first query, the second query, and/or the third query, determine the target transformation scenario stored in the scenario DB by using the combination of the received queries as a search condition or a search filtering criterion, and perform the transformation of the target artificial intelligence model according to the determined target transformation scenario. For example, the computing device 100 may determine the target transformation scenario, by using one of the first query, the second query, and the third query as a first-order filtering condition, another one as a second-order filtering condition, and the remaining one as a third-order filtering condition. For example, the computing device 100 may determine the target transformation scenario, by using a combination of the first query, the second query, and the third query as a single filtering condition. For example, the computing device 100 may determine the target transformation scenario by using two pieces of information from the first query, the second query, and the third query as a first-order filtering condition, and the remaining one piece of information as a second-order filtering condition. By performing first-order, second-order, and/or third-order filtering by combining the first query, the second query, and the third query, a target transformation scenario corresponding to the query can be determined in a resource-efficient manner. For example, the computing device 100 may calculate the model similarity between the target artificial intelligence model included in the first query and the models stored on the scenario DB, and may search for candidate transformation scenarios by using the model similarity as a filtering criterion or a search condition. The computing device 100 may determine the target transformation scenario from among the candidate transformation scenarios by using the target platform information included in the second query and the target performance information included in the third query as additional filtering criteria or search conditions. For example, the computing device 100 may determine the execution mode of the target artificial intelligence model from the first query, and may perform a first-order filtering on the transformation scenarios stored on the scenario DB by using the determined execution mode as a single filtering condition or as a filtering condition in combination with other information. Then, the computing device 100 may perform a second-order filtering on the scenario DB by using the model similarity between the target artificial intelligence model obtained from the first query and the models in the scenario DB, the target platform identification information obtained from the second query, and/or the target performance information obtained from the third query. The techniques according to an embodiment of the present disclosure can enable the determination of a resource-efficient target transformation scenario, by sequentially performing N-th order filtering (where N is a natural number) using the information obtained from the queries. The techniques according to an embodiment of the present disclosure can enable the determination of a resource-efficient target transformation scenario by performing a single filtering determined by combining the information obtained from the queries.

In an embodiment, the flowchart illustrated in FIG. 3 illustratively shows an execution process of a transformation scenario. In an embodiment, the flowchart illustrated in FIG. 3 illustratively shows a process in which model optimization and/or model transformation for a target artificial intelligence model corresponding to a query is performed using a constructed scenario DB, a process in which verification of the transformed model is performed through simulation, and/or a process in which the scenario DB is updated using the verification result. In an embodiment, as the target artificial intelligence model is transformed according to the flowchart of FIG. 3, performance optimization of the target artificial intelligence model can be achieved in a resource-efficient manner, and/or the reliability of the scenario DB can be increased as the scenario DB is dynamically updated using the simulation result.

In an embodiment, the computing device 100 may determine the execution mode of the target artificial intelligence model by analyzing the query(s) received from a user terminal. If the execution mode of the target artificial intelligence model is determined to be the Eager execution mode, the computing device 100 may perform a pre-transformation on the target artificial intelligence model by executing or applying a trainer, a compressor (e.g., Advanced Compressor), and/or a quantizer (e.g., Advanced Quantizer) to the target artificial intelligence model. This pre-transformation may refer to a transformation for enabling the target artificial intelligence model to be transformed into the form of an intermediate representation structure, which is a graph structure. The artificial intelligence model in the Eager execution mode to which the pre-transformation has been applied can be transformed into a graph structure, and accordingly, can be transformed into an intermediate representation structure, so that model optimization tools according to a transformation scenario can be applied or executed on the intermediate representation structure.

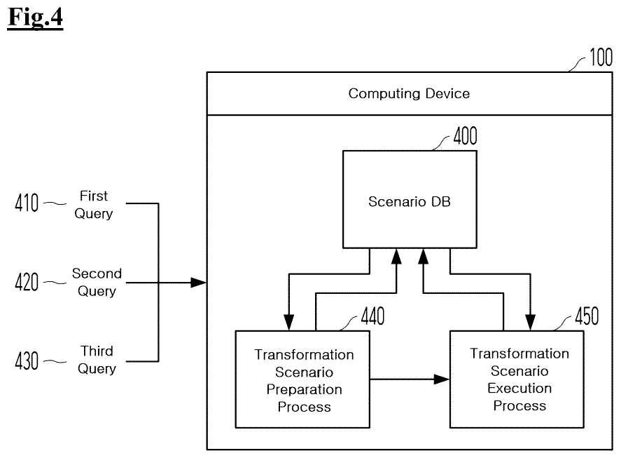

FIG. 4 is a diagram illustratively showing a transformation scenario preparation process and a transformation scenario execution process according to an embodiment of the present disclosure.

As illustrated in FIG. 4, the scenario DB 400 may be capable of interoperating with the transformation scenario preparation process 440. The scenario DB 400 may be capable of interoperating with the transformation scenario execution process 450.

In an embodiment, the computing device 100 may receive a first query 410, a second query 420, and/or a third query 430, and may construct the scenario DB 400 by using the received queries, and/or may determine a transformation scenario stored in the scenario DB 400 based on the received queries and perform the transformation scenario execution process 450 by using the determined transformation scenario. For example, the first query 410 may include information related to an artificial intelligence model. For example, the second query 420 may include information related to a platform on which the artificial intelligence model is to be executed. For example, the third query 430 may include information about a user environment and/or target performance information. By using these queries, a transformation scenario is determined in consideration of the artificial intelligence model, platform, user environment, and/or target performance, and by using the determined transformation scenario, the optimization and/or transformation of the artificial intelligence model can be performed automatically and/or efficiently.

In an embodiment, the computing device 100 may construct the scenario DB 400 through the transformation scenario preparation process 440. For example, the computing device 100 may construct the scenario DB 400 by using the first query 410, the second query 420, and/or the third query 430. For example, the computing device 100 may generate a candidate transformation scenario by using model analysis information and platform analysis information, and may store the generated candidate transformation scenario in the scenario DB 400. For example, the computing device 100 may generate a candidate transformation scenario and its performance prediction value by applying candidate model optimization tools to the candidate transformation scenario generated by using the model analysis information and platform analysis information. For example, the computing device 100 may store in the scenario DB 400 the information generated by using the candidate transformation scenario, the performance prediction value, and/or the order rule of the model optimization tools. For example, the computing device 100 may generate a transformation scenario by automatically arranging a plurality of model optimization tools based on the artificial intelligence model, hardware, compiler, and/or performance value (e.g., expected performance). The generated transformation scenario is stored in the scenario DB 400 and may be utilized by the transformation scenario execution process 450.

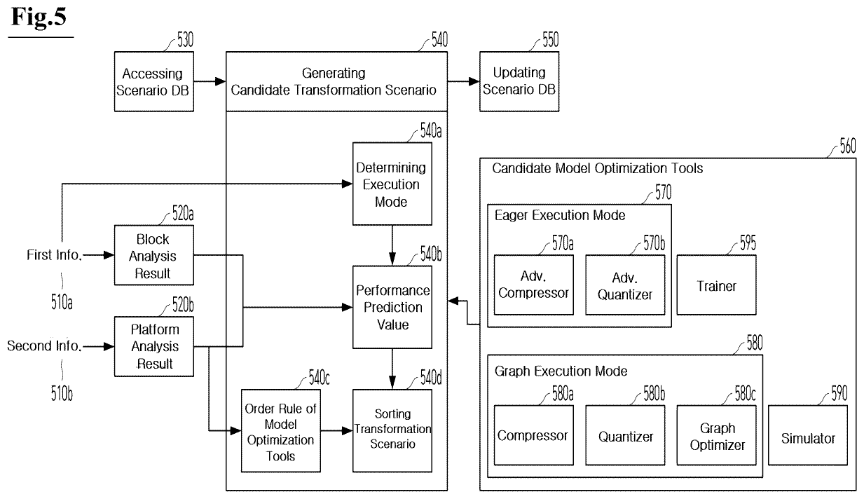

The transformation scenario preparation process 440 will be described in detail later with reference to FIG. 5.

In an embodiment, the computing device 100 may perform the transformation scenario execution process 450 by using the constructed scenario DB 400. For example, the computing device 100 may determine a target transformation scenario that satisfies the conditions of the queries on the scenario DB 400 by using the first query 410, the second query 420, and/or the third query 430, and may perform the transformation of the artificial intelligence model by using the target transformation scenario. For example, the computing device 100 may generate a simulation result for the transformed artificial intelligence model and may determine whether to update the scenario DB 400 by using the simulation result. For example, if a difference between the simulation result and the expected value on the scenario DB 400 is greater than or equal to a threshold, or if the simulation result is less than the expected value on the scenario DB 400, the computing device 100 may perform a second transformation on the artificial intelligence model based on the simulation result and may reflect the execution result of the second transformation in the scenario DB 400.

FIG. 5 is a diagram illustratively showing a transformation scenario preparation process according to an embodiment of the present disclosure.

In an embodiment, the computing device 100 may receive first information 510a and may generate a block analysis result 520a by using the first information 510a. For example, the first information 510a may include information about an artificial intelligence model to be stored in the scenario DB. For example, the block analysis result 520a may include analysis information of the artificial intelligence model, indicating the operators (or layers) constituting the artificial intelligence model and/or the connection relationship of the operators. For example, the block analysis result 520a may include block-unit analysis information corresponding to a set of operators constituting the artificial intelligence model. For example, the computing device 100 may divide the artificial intelligence model into units of blocks and/or operators (or layers) and generate an analysis result (e.g., a performance analysis result such as accuracy) for the divided units. For example, as a result of analyzing the artificial intelligence model, if the execution mode of the artificial intelligence model is determined to be the Eager execution mode, the computing device 100 may store code information in the scenario DB in units of blocks and/or operators (or layers). For example, as a result of analyzing the artificial intelligence model, if the execution mode of the artificial intelligence model is determined to be the Graph execution mode, the computing device 100 may store graph abstraction information in the scenario DB in units of blocks and/or operators (or layers). Such code information and/or graph abstraction information may be used in the process of calculating the model similarity of the artificial intelligence model. The aforementioned information may be included in the scope of the block analysis result 520a. In an additional embodiment, depending on the implementation aspect, the block analysis result 520a may also be used in a sense that encompasses the analysis result for the artificial intelligence model.

In an embodiment, the block analysis result 520a may include the inference accuracy of the artificial intelligence model, predicted in units of a block comprising one or more operators constituting the artificial intelligence model. In an embodiment, the block analysis result 520a may include information for identifying the execution mode of the artificial intelligence model (e.g., Eager execution mode or Graph execution mode).

An artificial intelligence model may include a plurality of operators (or layers). In the present disclosure, a layer may refer to a stepwise operational unit that includes one or more operators performing operations within the artificial intelligence model. The computing device 100 may receive an artificial intelligence model from an external server or a user terminal connected wirelessly or by wire, or may obtain an artificial intelligence model developed based on the connection relationship and attributes of layers set according to a user input. Receiving an artificial intelligence model may be used in an interchangeable sense with receiving a user input that defines the structure of the artificial intelligence model, including the connection relationship and attributes of layers.

In an embodiment, as artificial intelligence technology develops, numerous types and a vast number of artificial intelligence models are being developed and released. It is practically impossible to collect all of these artificial intelligence models and build a DB. The computing device 100 may divide a received artificial intelligence model into units of blocks (e.g., a set or combination of operators) and may measure or obtain the performance when each of the model optimization tools is executed for each of the divided blocks. By combining the execution performance collected in block units, the performance when each of the model optimization tools is executed on the artificial intelligence model can be predicted. For example, assume that the blocks constituting an artificial intelligence model are block A, block B, and block C. Assume that the accuracy decrease when the first model optimization tool is executed on block A is A, the accuracy decrease when the first model optimization tool is executed on block B is B, and the accuracy decrease when the first model optimization tool is executed on block C is C. Under this assumption, the expected performance change when the first model optimization tool is executed on the entire corresponding artificial intelligence model can be predicted through an arithmetic operation on A, B, and C. For example, the arithmetic operation on A, B, and C may include addition, multiplication, a weighted operation, and/or an average, etc.

In an embodiment, the computing device 100 may construct a transformation scenario by combining a performance prediction value for an artificial intelligence model, the artificial intelligence model, a platform, and/or a user environment. The computing device 100 may store the constructed transformation scenario in the scenario DB. For example, the computing device 100 may measure the identification information and the number of each of the blocks included in the artificial intelligence model, and may generate a performance value as a combination of a block unit and a model optimization tool unit. Even for the same type of block, parameters such as weights and activation functions may be different. For example, even if the operators are the same, the computing device 100 may additionally measure the number of parameters and classify and manage them as different blocks. For example, the computing device 100 may measure a statistical value (e.g., an average value, etc.) for the accuracy drop for the same blocks and may also construct the scenario DB by using this statistical value. The performance value may include, for example, the amount of change in accuracy, the amount of change in latency, and/or the compression rate, compression ratio, etc., and this performance or performance change value may be expressed in the form of an absolute value, a relative value, and/or a ratio, etc.

In an additional embodiment, the computing device 100 may apply a model optimization tool to the entire artificial intelligence model and may measure or calculate a performance value or a performance change value (e.g., the amount of change in lightweighting and the amount of change in accuracy) for the entire model. The computing device 100 may estimate the performance value or the performance change value (e.g., accuracy drop value, etc.) for each of the blocks constituting the model by using the size that the block occupies within the model and/or the degree of lightweighting of the block within the model. For example, if the model optimization tool is a compressor, the performance change value may include the amount of change in lightweighting, the amount of change in accuracy, and/or the amount of change in inference speed of the artificial intelligence model as the compressor is applied to the artificial intelligence model. For example, if the model optimization tool is a quantizer, the performance change value may include the amount of change in lightweighting, the amount of change in accuracy, and/or the amount of change in inference speed of the artificial intelligence model as the quantizer is applied to the artificial intelligence model.

In an additional embodiment, the computing device 100 may apply some of the numerous optimization methods and may estimate the performance value or the performance change value for the remaining related optimization methods by using interpolation and/or extrapolation. For example, the computing device 100 may apply model optimization tools indicating degrees of lightweighting of 20%, 40%, and 60% to an artificial intelligence model (or a block), and may estimate the performance value or the performance change value for degrees of lightweighting other than 20%, 40%, and 60% by using an estimation method of interpolation and/or extrapolation. This estimated value may be stored in the scenario DB.

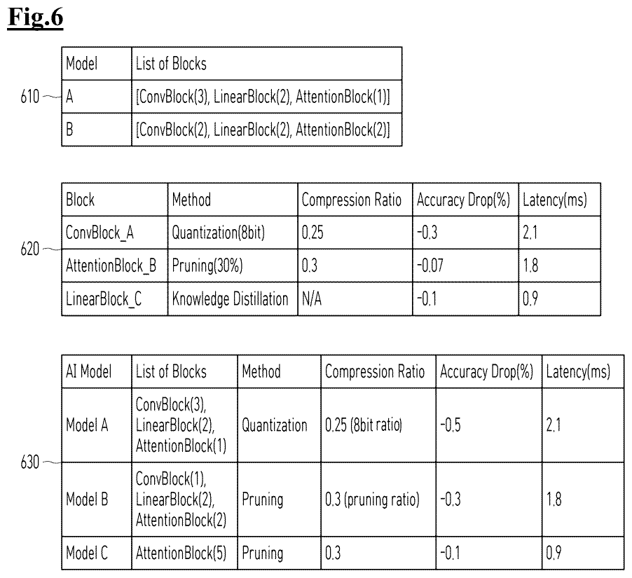

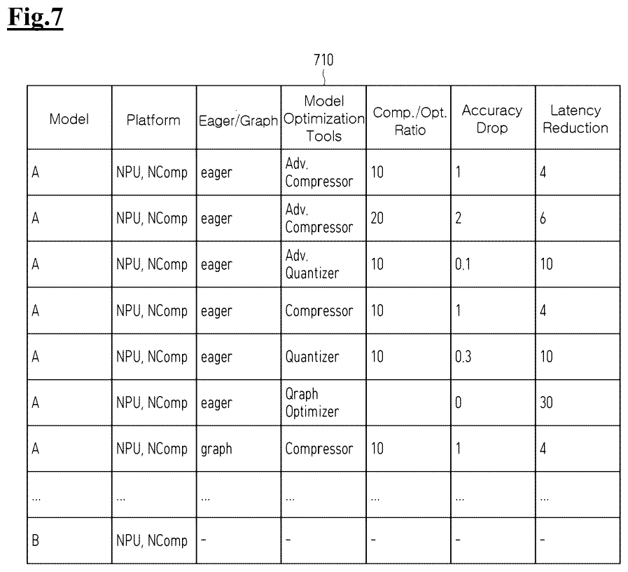

The results of the scenario DB construction described above will be described in detail below with reference to FIG. 6.

In an embodiment, the computing device 100 may generate a platform analysis result 520b by analyzing or parsing second information 510b. The platform analysis result 520b may be generated by the computing device 100 based on information related to hardware and/or information related to a compiler included in the second information 510b. The platform analysis result 520b may refer to an analysis result for the hardware and/or compiler, and may be used to generate a performance prediction value 540b in combination with the block analysis result 520a. The platform analysis result 520b may refer to any form of information obtained by using the hardware information and/or the compiler information.

In an embodiment, the computing device 100 may determine a hardware constraint by using the hardware information included in the second information 510b and may generate a platform analysis result 520b including the hardware constraint. For example, the hardware constraint may include operators supported by the hardware, operators not supported by the hardware, and/or parameters supported by the hardware.

In an embodiment, the computing device 100 may determine a compiler constraint by using the compiler information included in the second information 510b and may generate a platform analysis result 520b including the compiler constraint. For example, the compiler constraint may include operators supported by the compiler, operators not supported by the compiler, and/or parameters supported by the compiler.

In an embodiment, the platform analysis result 520b may be used to define the order rule of model optimization tools. The arrangement order of the model optimization tools may be varied according to the hardware and/or compiler. The precedence relationship between model optimization tools may be varied according to the hardware and/or compiler. Whether a model optimization tool follows or precedes another may be determined according to the hardware and/or compiler.

In an embodiment, the order rule 540c may also be determined based on the block analysis result 520a. In an embodiment, the order rule 540c may also be determined based on a combination of the platform analysis result 520b and the block analysis result 520a.

For example, the order rule 540c may include a rule that a model optimization tool that runs in the Eager execution mode should be executed before a model optimization tool that runs in the Graph execution mode. For example, the order rule 540c may include a rule that a quantizer should be executed after the execution of a graph optimizer. The order rule 540c may represent rule information for determining the precedence relationship between model optimization tools and the existence or nonexistence between model optimization tools.

In an embodiment, the platform analysis result 520b may be used to define the arrangement order of the model optimization tools to be included in a transformation scenario within the transformation scenario. For example, the platform analysis result 520b may be used to determine whether to include a specific model optimization tool in a transformation scenario.

In an embodiment, the computing device 100 may generate a platform analysis result 520b including data type information, memory information, and/or execution unit information (of an operator or a model) by using the hardware information and/or the compiler information included in the second information 510b.

In an embodiment, the computing device 100 may access the scenario DB (530) and may store in the scenario DB a performance prediction value 540b generated by using the block analysis result 520a and the platform analysis result 520b. As described above, the scenario DB can store and manage transformation scenarios that identify combinations of model optimization tools used or executed for the transformation of an artificial intelligence model (e.g., transformation for optimization). Each of the transformation scenarios may be stored on the scenario DB so as to include the execution order of the model optimization tools within the transformation scenario and a performance prediction value 540b.

In an embodiment, the performance prediction value 540b may refer to a performance value assuming when the expected artificial intelligence model is executed on a platform, without executing the artificial intelligence model on the platform. In an embodiment, the performance prediction value 540b may refer to an estimated artificial intelligence model performance value, without executing the artificial intelligence model.

In an embodiment, the performance prediction value 540b may be an estimated execution performance or an estimated change amount of the execution performance of an artificial intelligence model when the artificial intelligence model to which model optimization tools have been applied is executed on a platform, and may include at least one of an accuracy of the artificial intelligence model, an inference speed of the artificial intelligence model, and a degree of lightweighting of the artificial intelligence model.

For example, the computing device 100 may divide an artificial intelligence model into units of blocks comprising one or more operators. The computing device 100 may measure the sub-execution performance of a combination unit of a block and a model optimization tool by applying or executing each of the model optimization tools on each of the divided blocks. The sub-execution performance herein may be used to express the execution performance of a part of a model (e.g., a block within the model), not the execution performance of the entire model. The computing device 100 may estimate the amount of change in the execution performance of the artificial intelligence model when each of the model optimization tools is applied, by combining the measured sub-execution performances for each of the blocks constituting the artificial intelligence model. This amount of change in execution performance may be included in the performance prediction value 540b.

In an embodiment, the performance prediction value 540b may be generated based on the block analysis result 520a and/or the platform analysis result 520b.

In an embodiment, the platform analysis result 520b may be used to execute a model optimization tool on an artificial intelligence model. For example, the applicable lightweighting method or pruning ratio in a compressor may be varied according to the hardware characteristics. For example, quantization according to the data type may be possible in a quantizer if there is characteristic information about the platform. For example, a graph optimizer can perform pattern matching with operators supported by the hardware and/or compiler by using the hardware information and/or the compiler information. As such, the model optimization tool to be applied to the artificial intelligence model may be dependently varied according to the platform analysis result 520b. The parameters used in a model optimization tool may be dependently varied according to the platform analysis result 520b, which indicates the characteristics of the hardware and/or compiler. The optimization method used in a model optimization tool may be dependently varied according to the platform analysis result 520b, which indicates the characteristics of the hardware and/or compiler. The scenario DB may store a model optimization tool, the operating method of the model optimization tool, and/or the parameters of the model optimization tool. In an embodiment, the performance prediction value 540b may include latency, and the scenario DB may also store this latency. Since latency is a value that can be measured and/or predicted only when the hardware and/or compiler are specified, the platform analysis result 520b can be used in generating the performance prediction value 540b together with the block analysis result 520a.

In an embodiment, the platform analysis result 520a may include a constraint of the platform, an operator supported by the platform, a data type supported by the platform, and an execution unit of the platform.

In an embodiment, the scenario DB may include identification information of an artificial intelligence model or identification information of a block of an artificial intelligence model. In an embodiment, the scenario DB may include identification information of a model optimization tool or identification information of an optimization scheme. In an embodiment, the scenario DB may include performance information related to an artificial intelligence model to which a model optimization tool or an optimization scheme has been applied. In an embodiment, the scenario DB can store and manage, in the form of a table structure, information necessary to generate a target transformation scenario corresponding to a user query. Each of the transformation scenarios stored in the scenario DB may include a performance prediction value 540b for a combination of an artificial intelligence model and a platform, when model optimization tools are applied to the artificial intelligence model.

In an embodiment, the computing device 100 may receive first information 510a for identifying a candidate artificial intelligence model and second information 510b for identifying a candidate platform on which to execute the candidate artificial intelligence model. The computing device 100 may generate a block analysis result 520a for blocks constituting the candidate artificial intelligence model by using the first information 510a, and may generate a platform analysis result 510b indicating a constraint for the candidate platform by using the second information 510b. The computing device 100 may generate a performance prediction value 540b for a combination of the candidate artificial intelligence model and the candidate platform when a candidate model optimization tool is applied to the candidate artificial intelligence model, by using the block analysis result and the platform analysis result. The computing device 100 may generate a candidate transformation scenario 540 comprising the first information 510a, the second information 510b, information about the candidate model optimization tool(s), and the performance prediction value 540b. The generated candidate transformation scenario may be stored and managed in the scenario DB.

The computing device 100 may determine the execution mode (540a) based on at least first information 510a. For example, the computing device 100 may determine whether the execution mode is Eager execution mode or Graph execution mode.

In an embodiment, the computing device 100 may sort a transformation scenario within the scenario DB by using the performance prediction value 540b (540d). Sorting of a transformation scenario (540d) may refer to sorting or arranging the order of model optimization tools within the transformation scenario. For example, the computing device 100 may determine the model optimization tool to be assigned to a specific position (e.g., a specific order) within the transformation scenario based on the performance prediction value 540b of each of the model optimization tools, in order to satisfy a target performance including accuracy, inference speed, and/or memory usage.

In an embodiment, the sorting of a transformation scenario (540d) may include sorting the arrangement order of transformation scenarios within the scenario DB. For example, the computing device 100 may determine the optimal order of model optimization tools and/or their parameters by using the performance prediction value 540b of each of the model optimization tools, in order to satisfy a target performance including accuracy, inference speed, and/or memory usage. Each of the transformation scenarios may be managed in a form sorted within the scenario DB according to the performance prediction value of each transformation scenario. For example, for a specific model and platform, assume that the performance prediction value 540b for a first transformation scenario, which has the order of a compressor with a compression ratio (lightweighting) of 10%, a graph optimizer, and a quantizer with Int 8:Int16=1:9, is an accuracy decrease of 1% and an inference speed decrease of 10%. For the specific model and platform, assume that the performance prediction value 540b for a second transformation scenario, which has the order of an Advanced quantizer, a compressor with a compression ratio (lightweighting) of 10%, a graph optimizer, and a quantizer with Int 8:Int16=2:8, is an accuracy decrease of 1% and an inference speed decrease of 30%. Under these assumptions, the second transformation scenario, which has better performance than the first transformation scenario, may be placed preferentially within the scenario DB compared to the first transformation scenario or may be recommended as a target transformation scenario.

In an embodiment, the computing device 100 may generate a first order rule indicating an application order of a plurality of candidate model optimization tools 560 according to an execution mode of the artificial intelligence model, and a second order rule indicating the application order of the plurality of candidate model optimization tools 560 by using a correlation between the plurality of candidate model optimization tools 560. For example, the order rule 540c may be variably determined based on the execution mode of the model. For example, a different order rule may be generated depending on whether it is an Eager execution mode 570 or a Graph execution mode 570. For example, the order rule 540c may be variably determined based on the correlation between model optimization tools. For example, whether the next model optimization tool is placed within the transformation scenario may be determined according to the previous model optimization tool. For example, an order rule may be generated that a specific model optimization tool cannot come after another specific model optimization tool. The computing device 100 may generate a candidate transformation scenario 540 including an execution order in which the plurality of candidate model optimization tools 560 are executed on the candidate artificial intelligence model, by using the first order rule and the second order rule.

In an embodiment, the computing device 100 may generate a performance change prediction value corresponding to each of a plurality of candidate model optimization tools 560 and may determine the model optimization tool to be matched with the combination of a specific model and platform from among the plurality of candidate model optimization tools 560 by giving priority in descending order of a quantitative value of performance change within the performance change prediction value. In an embodiment, the computing device 100 may determine the inference speed corresponding to each of a plurality of candidate model optimization tools 560 and may determine the model optimization tool to be matched with the combination of a specific model and platform from among the plurality of candidate model optimization tools 560 by giving priority in descending order of the value of the inference speed. In this manner, transformation scenario sorting (540d) may be performed.

In an embodiment, the computing device 100 may generate a candidate transformation scenario (540) by using a combination of various artificial intelligence models and various platforms, and may update the scenario DB by using the generated candidate transformation scenario (550). In this manner, various candidate transformation scenarios can be stored and managed in the scenario DB. In this manner, the scenario DB can be constructed.

In an embodiment, candidate model optimization tools 560 may be used in the process of generating a candidate transformation scenario (540) to be stored in the scenario DB. For example, the candidate model optimization tools 560 may be classified and managed according to the execution mode of the artificial intelligence model. The candidate model optimization tools 560 may be classified and stored according to the model execution mode. According to the model execution mode included in the first information 510a and/or the block analysis result 520a, the candidate model optimization tools to be included or not included in the transformation scenario may be determined.

In an embodiment, if the execution mode of the model is determined to be the Eager execution mode 570, the model optimization tool to be included in the candidate transformation scenario may be determined from among an Adv. Compressor 570a and an Adv. Quantizer 570b. After at least one of the above model optimizers 570a and 570b is included in the candidate transformation scenario, model optimization tools 580a, 580b and 580c operable in the Graph execution mode 580 may also be added to the corresponding candidate transformation scenario. In an embodiment, if the execution mode of the model is determined to be the Graph execution mode 580, the model optimization tool to be included in the candidate transformation scenario may be determined from among the model optimization tools 580a, 580b and 580c. In an embodiment, a Trainer 595 and/or a Simulator 590 may also be included in the candidate transformation scenario or may be applied after the model transformation according to the candidate transformation scenario is completed. In an additional embodiment, a Trainer 595 and/or a Simulator 590 may also be applied to the corresponding model before the model transformation according to the candidate transformation scenario is performed. A detailed description of each of the candidate model optimization tools 560 will be replaced with the description in other parts of the specification.

FIG. 6 is a diagram illustratively showing a process of generating a block analysis result and information included in a scenario database according to an embodiment of the present disclosure.

In an embodiment, reference numeral 610 represents a block analysis result illustratively showing a list of the blocks within a model and the model. In an embodiment, reference numeral 610 expresses identification information of a model and identification information of blocks within the model in a two-dimensional structure. The two-dimensional structure may, for example, include a table structure. In an embodiment, reference numeral 610 illustratively shows the result of dividing a model into block units in the process of generating a block analysis result of an artificial intelligence model.

In an embodiment, reference numeral 620 illustratively shows performance for a combination of a model optimization tool and a block, the blocks and the model optimization tool. In an embodiment, reference numeral 620 illustratively shows the result of applying a model optimization tool for each block divided in reference numeral 610. In an embodiment, reference numeral 620 expresses identification information of a block, identification information of a model optimization tool, and a performance value or performance change amount information for when a model optimization tool is applied to the block, for example, in a table structure. The performance value or performance change amount information herein may include a compression ratio, accuracy drop, latency change and/or latency. The performance value or performance change amount information herein represents performance information according to the combination of a block and a model optimization tool (and its optimization scheme). As performance information for each combination between a model optimization tool (and its optimization scheme) and a block is displayed two-dimensionally as described above, information on various performances for each model optimization tool per block can be stored and managed.

In an embodiment, reference numeral 630 illustratively shows a table structure of a combination of reference numerals 610 and 620. Reference numeral 630 illustratively shows the performance (e.g., estimated performance) for each artificial intelligence model. Reference numeral 630 shows the result of mapping an operation value (e.g., a statistical value such as a sum value or a multiplication value) of the performance information in the table structure of reference numeral 620 for each model, by extracting the blocks included in the model in reference numeral 610 from the table structure of reference numeral 620. The performance information in reference numeral 630 is performance information according to a combination of blocks and may represent estimated information that can be obtained without actually executing the artificial intelligence model.

In an embodiment, the data structure illustrated in reference numerals 610, 620, and/or 630 may be stored in the scenario DB and managed within the scenario DB. In an embodiment, the information illustrated in reference numerals 610, 620, and/or 630 may be stored and/or managed by being mapped with a transformation scenario in the scenario DB.

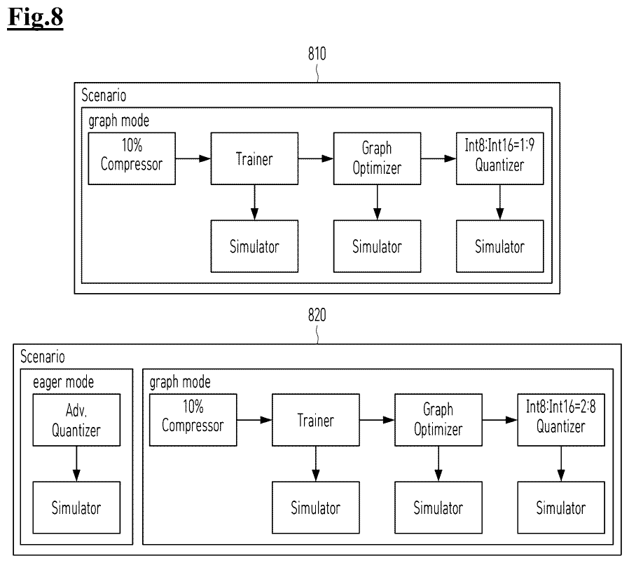

FIG. 7 is a diagram illustratively showing information included in a scenario database according to an embodiment of the present disclosure.

In an embodiment, the information 710 in FIG. 7 may represent a data structure of a N-dimensional structure (e.g., a two-dimensional structure). The information 710 may be expressed in a table structure.

In an embodiment, the information 710 represents the execution mode of a model, a model optimization tool, and/or performance information (e.g., a performance value and/or a performance change amount) for each combination of a model and a platform.

The information 710 in FIG. 7 may be stored in the scenario DB. The scenario DB can manage by mapping a transformation scenario and the information 710 of FIG. 7.

In an embodiment, a combination of FIG. 6 and FIG. 7 is also implementable. A combination of FIG. 6 and FIG. 7 may include, for example, the information 610, 620, and/or 640 in FIG. 6 being reflected in the information 710 of FIG. 7, and the information in FIG. 7 being reflected in the information of FIG. 6. A combination of FIG. 6 and FIG. 7 may mean, for example, that a part of the information of FIG. 6 is replaced with a part of the information of FIG. 7, or a part of the information of FIG. 7 may be replaced with a part of the information of FIG. 6. For example, a column representing information about a platform, a column including information for identifying an execution mode (e.g., eager or graph), a column for identifying a model optimization tool, a column representing an optimization ratio, and/or a column representing the amount of change in latency may be added to the information 610, 620, and 630 in FIG. 6. For example, the information 710 in FIG. 7 may be expressed as information 610 that maps a model and a list of blocks constituting the model. For example, the information 710 in FIG. 7 may be expressed in the form of a table that two-dimensionally maps a block, a platform, an execution mode, a model optimization tool, a model optimization method, and/or a performance change due to model optimization. For example, the information 710 in FIG. 7 may be expressed in the form of a table that two-dimensionally maps a model, blocks constituting the model, a platform, an execution mode, a model optimization tool, a model optimization method, and/or a performance change due to model optimization.

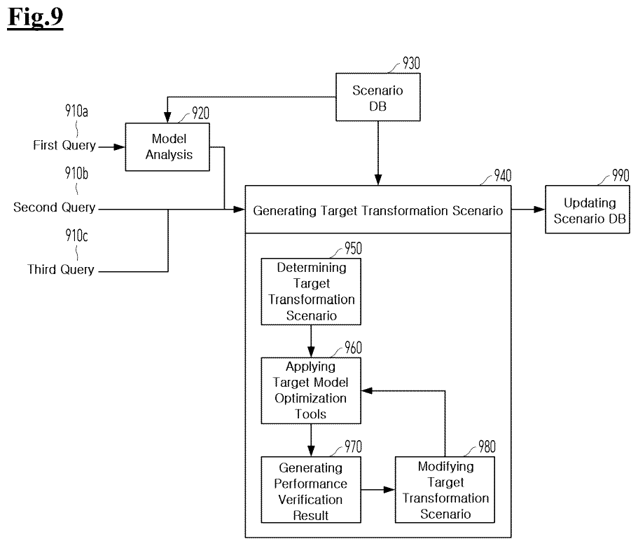

FIG. 8 is a diagram illustratively showing transformation scenarios in a scenario database according to an embodiment of the present disclosure.

Reference numeral 810 illustratively shows model optimization tools included in a single scenario. As illustrated in reference numeral 810, the scenario 810 is applicable when the artificial intelligence model is in a Graph execution mode. The scenario 810 may have an order of a compressor having a parameter or operating scheme of 10%, a trainer, a graph optimizer, and a quantizer having a parameter or operating scheme of Int 8:Int16=1:9. A simulator may be connected to the output of at least some of the model optimization tools arranged in the scenario 810, so that an estimated simulation result for the optimization performance for each of the model optimization tools can be generated. The estimated simulation result may be stored and/or managed by being mapped with the scenario 810 in the scenario DB.

Reference numeral 820 also illustratively shows model optimization tools included in a single scenario. As illustrated in reference numeral 820, the scenario 820 is applicable when the artificial intelligence model is in an Eager execution mode. Within the scenario 820, an Adv. Quantizer on the Eager execution mode can be preferentially executed on an artificial intelligence model having the Eager execution mode. Following the Adv. Quantizer, one or more model optimization tools operable on the Graph execution mode may be arranged in the scenario 820. The scenario 820 may have an order of a compressor having a parameter or operating scheme of 10%, a trainer, a graph optimizer, and a quantizer having a parameter or operating scheme of Int 8:Int16=2:8. A simulator may be connected to the output of at least some of the model optimization tools arranged in the scenario 820, so that an expected simulation result for the optimization performance for each of the model optimization tools can be generated. The expected simulation result may be stored and/or managed by being mapped with the scenario 820 in the scenario DB.

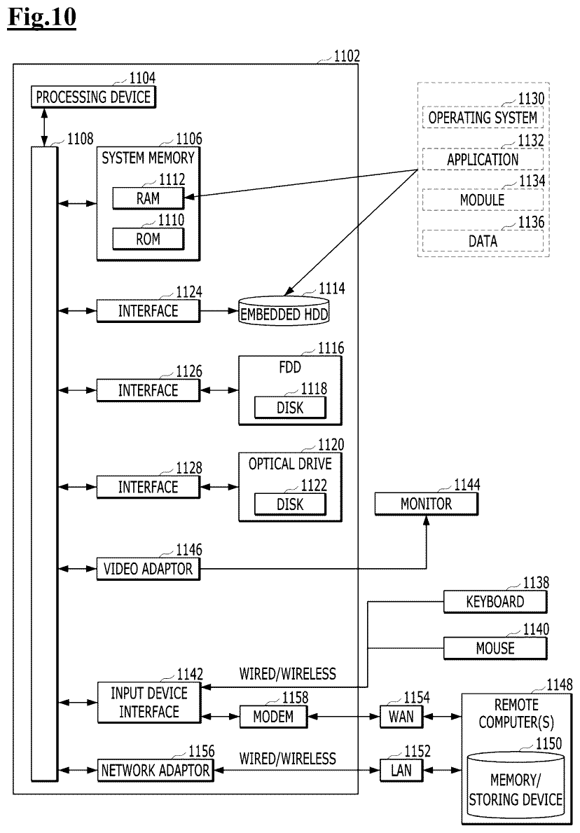

FIG. 9 is a diagram illustratively showing a transformation scenario execution process according to an embodiment of the present disclosure.

Features in the transformation scenario execution process in FIG. 9 that are redundant with the features described above will be replaced with the features described above, and will be omitted from the description in FIG. 9.

In an embodiment, the computing device 100 may receive a first query 910a, a second query 910b, and/or a third query 910c. For example, the first query 910a may include information related to an artificial intelligence model. For example, the second query 910b may include information related to a platform on which the artificial intelligence model is to be executed. For example, the third query 910c may include information related to a target performance according to a combination of the artificial intelligence model and the platform.

In an embodiment, the computing device 100 may perform a model analysis 920 that determines the model similarity of each of the artificial intelligence models stored in the scenario DB 930 with the target artificial intelligence model in the first query 910a. For example, the model similarity may refer to a value that quantitatively represents the similarity between models. For example, the model similarity may refer to a value that quantitatively represents a structural similarity or an operational similarity between models. For example, the model similarity may be determined by a method of dividing an artificial intelligence model into units of blocks or operators and combining the similarities between the divided units. For example, the model similarity may be determined by a method of dividing an artificial intelligence model into units of blocks or operators, representing the divided units in a vector space, and calculating the similarity in the vector space.

In an embodiment, the computing device 100 may generate a target transformation scenario 940 by combining the result of the model analysis 920 and the second query 910b and/or the third query 910c. The target transformation scenario may refer to a set of target model optimization tools that match the queries.

In an embodiment, the computing device 100 may determine a target transformation scenario 950 from the scenario DB 930 by utilizing the combined result of the result of the model analysis 920 and the second query 910b and/or the third query 910c as a search condition. With the techniques according to an embodiment of the present disclosure, when a user inputs information related to a desired model, platform, and performance in a manner that maximizes user convenience (e.g., text input and/or object selection, etc.), the computing device 100 performs query rewriting (e.g., setting search conditions and/or filtering criteria, etc.) through the combination of these queries, and the target transformation scenario on the scenario DB 930 can be automatically and efficiently searched through the rewritten query.

In an embodiment, the computing device 100 may generate a transformed or optimized target artificial intelligence model 960 by applying or executing the target model optimization tools on the target artificial intelligence model. For example, the computing device 100 may transform the target artificial intelligence model by sequentially executing the target model optimization tools on the target artificial intelligence model according to the order identified in the target transformation scenario. For example, the computing device 100 may generate a post-transformation performance result of the transformed target artificial intelligence model by executing the target model optimization tools included in the target transformation scenario on the target artificial intelligence model according to the order according to the target transformation scenario. For example, in the process of generating the transformed or optimized target artificial intelligence model, the target artificial intelligence model may be transformed into an intermediate representation structure, which is a graph structure including a node representing an atomic operator that is no longer decomposed (framework-independent) and a module representing a set of nodes and being framework-dependent. The intermediate representation structure may further comprise a tensor representing the connection of nodes and/or the connection of modules. The intermediate representation structure may be modified as model optimization tools are applied on the intermediate representation structure. An expected simulation result of a simulator may be generated by using the modified intermediate representation structure. The expected simulation result may be used to generate a performance verification result 970.

In an embodiment, the computing device 100 may determine whether to modify the target transformation scenario by comparing the expected simulation result generated through the simulator with a predicted performance value of the target transformation scenario and/or the target optimization tool stored in the scenario DB 930. The computing device 100 may determine to modify the target transformation scenario if the expected simulation result is less than the predicted performance value, or if the expected simulation result is outside a predicted performance range determined based on the predicted performance value, or if the expected simulation result is outside a predicted performance degradation range determined based on the predicted performance value. The computing device 100 may modify the target transformation scenario 980. For example, the computing device 100 may modify the target transformation scenario in the manner of changing the predicted performance value stored on the scenario DB 930 based on the expected simulation result. Accordingly, an update 990 of the scenario DB may be performed. For example, the update 990 of the scenario DB may be dependent on whether the target transformation scenario is modified. For example, the computing device 100 may determine a transformation scenario other than the target transformation scenario determined in reference numeral 950 as the target transformation scenario. Reference numerals 960 and 970 are re-executed by using the other transformation scenario, and accordingly, whether to update 990 the scenario DB may be determined. For example, the update 990 of the scenario DB may be dependent on the re-execution result of reference numerals 960 and 970.

In an embodiment, the modification 980 of the target transformation scenario may include changing the combination of model optimization tools included in the target transformation scenario.

In an embodiment, the modification 980 of the target transformation scenario may include changing a parameter of a model optimization tool. For example, in the case of a compressor, changing the pruning ratio, compression ratio, and/or filter decomposition rank (FD rank) may be included in the scope of changing the parameter. For example, in the case of a quantizer, changing how low the ratio of int8 and/or int16 will be, or changing whether to apply a float datatype, or changing the data type, or changing the ratio of Precision, or changing whether to apply a floating data type may be included in the scope of changing the parameter. For example, changing the quantization parameter of the quantizer may include at least one of changing the number of bits, changing the scaling method, and changing the zero point.

FIG. 10 is a simplified and general schematic diagram of an exemplary computing environment in which embodiments of the present disclosure may be implemented. FIG. 10 discloses an exemplary computing environment of the computing device 100.

Although the present disclosure is generally described above as being implementable by the computing device 100, one of ordinary skill in the art will appreciate that the present disclosure may be implemented in combination with computer-executable instructions that can be executed on one or more computing devices and/or other program modules, and/or as a combination of hardware and software.

Generally, program modules include routines, programs, components, data structures, and the like that perform particular tasks or implement particular abstract data types. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

FIG. 10 illustrates an exemplary environment that implements various aspects of the present disclosure including a computer 1102 and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114(e.g., EIDE, SATA)—which may alternatively be configured for external use within a suitable chassis (not shown)—a magnetic floppy disk drive (FDD) 1116(e.g., for reading from or writing to a mobile diskette 1118), and an optical disk drive 1120(e.g., for reading from or writing to a CD-ROM disk 1122 or other high-capacity optical media such as a DVD). The computer 1102 may also include an external hard disk drive (HDD) 1114 connected via ports such as USB, Thunderbolt, or eSATA. The hard disk drive 1114, magnetic disk drive 1116, and optical disk drive 1120 can each be connected to the system bus 1108 via a hard disk drive interface 1124, a magnetic disk drive interface 1126, and an optical drive interface 1128, respectively. The interface 1124 for external drive implementations includes at least one of, or both, USB (Universal Serial Bus) and IEEE 1394 interface technologies.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication computing device on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The description of the presented embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

What is claimed is:

1. A method, performed by a computing device, for transforming an artificial intelligence model for performance optimization of the artificial intelligence model, the method comprising:
receiving a first query for identifying a target artificial intelligence model to be subjected to transformation, and a second query for identifying a target platform on which the target artificial intelligence model is to be executed;
accessing a scenario database that stores a plurality of transformation scenarios, and determining a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model;
and transforming the target artificial intelligence model by applying target model optimization tools included in the target transformation scenario to the target artificial intelligence model.

2. The method of claim 1, wherein each of the plurality of transformation scenarios identifies a second combination of the model optimization tools for a first combination of an artificial intelligence model and a platform,
the model optimization tools comprise at least a compressor, a graph optimizer, and a quantizer, and
the platform comprises at least one of: a hardware on which an artificial intelligence model is to be executed, a compiler for connecting an artificial intelligence model to a hardware, and a runtime indicating an environment of a hardware on which an artificial intelligence model is to be executed.

3. The method of claim 1, wherein each of the plurality of transformation scenarios identifies an order in which the model optimization tools are applied to an artificial intelligence model, for a first combination of an artificial intelligence model and a platform.

4. The method of claim 3, wherein the transforming the target artificial intelligence model by applying the target model optimization tools included in the target transformation scenario to the target artificial intelligence model comprises:
transforming the target artificial intelligence model by sequentially applying the target model optimization tools to the target artificial intelligence model according to the order identified in the target transformation scenario.

5. The method of claim 3, wherein the order in which the model optimization tools are applied to the artificial intelligence model, which is identified in each of the plurality of transformation scenarios, is determined based on a performance change prediction value by each of the model optimization tools and a constraint according to the platform.

6. The method of claim 1, wherein the determining the target transformation scenario comprises:
calculating a model similarity between the target artificial intelligence model in the first query and models stored in the scenario database; and
determining the target transformation scenario to be applied to the target artificial intelligence model among the plurality of transformation scenarios, by using the model similarity, the target platform in the second query and a target performance value specified by a user as conditions.

7. The method of claim 1, wherein the determining the target transformation scenario comprises:
calculating a model similarity between the target artificial intelligence model in the first query and models stored in the scenario database;
determining a reference artificial intelligence model corresponding to the target artificial intelligence model among the models stored in the scenario database, based on a result of the calculation of the model similarity; and
determining a scenario that is mapped to a target performance value specified by a user and the target platform as the target transformation scenario, based on the reference artificial intelligence model.

8. The method of claim 1, wherein the scenario database has a table structure comprising:
identification information of an artificial intelligence model or identification information of a block of an artificial intelligence model;
identification information of a model optimization tool or identification information of an optimization scheme; and
performance information related to an artificial intelligence model to which the model optimization tool or the optimization scheme has been applied.

9. The method of claim 1, wherein each of the plurality of transformation scenarios indicates a performance prediction value for a first combination of an artificial intelligence model and a platform, when the model optimization tools are applied to the artificial intelligence model, and
the performance prediction value is an expected execution performance of an artificial intelligence model when the artificial intelligence model to which the model optimization tools have been applied is executed on a platform, and comprises at least one of: an accuracy of the artificial intelligence model, an inference speed of the artificial intelligence model and a degree of lightweighting of the artificial intelligence model.

10. The method of claim 9, wherein the performance prediction value is generated by:
dividing an artificial intelligence model into blocks comprising one or more operators;
measuring a sub-execution performance for each combination unit of a block and a model optimization tool, by applying each of the model optimization tools to each of the divided blocks; and
estimating an amount of change in execution performance of the artificial intelligence model when each of the model optimization tools is applied, by combining the measured sub-execution performances for each of the blocks constituting the artificial intelligence model.

11. The method of claim 9, wherein the receiving the first query and the second query comprises: receiving the first query, the second query, and a target performance value that serves as a criterion for the transformation of the target artificial intelligence model, and
the determining the target transformation scenario among the plurality of transformation scenarios comprises: determining the target transformation scenario to be applied to the target artificial intelligence model among the plurality of transformation scenarios, by using the first query, the second query and a comparison result between the target performance value and the performance prediction value.

12. The method of claim 1, wherein the determining the target transformation scenario to be applied to the target artificial intelligence model among the plurality of transformation scenarios comprises:
determining an execution mode of the target artificial intelligence model as one of an eager execution mode and a graph execution mode, based on an execution scheme of the target artificial intelligence model, from the first query, wherein the eager execution mode is a scheme of executing operations in an artificial intelligence model without converting to a graph, and the graph execution mode is a scheme of converting operations to a graph before execution of the artificial intelligence model; and
determining filtered transformation scenarios that include the determined execution mode among the plurality of transformation scenarios by using the determined execution mode as a filtering criterion, and determining the target transformation scenario to be applied to the target artificial intelligence model among the filtered transformation scenarios.

13. The method of claim 1, wherein the transforming the target artificial intelligence model by applying the target model optimization tools included in the target transformation scenario to the target artificial intelligence model comprises:
generating a performance verification result including an estimated inference simulation result for a case where the transformed target artificial intelligence model is executed on the target platform, by applying, through a simulator, the target model optimization tools included in the target transformation scenario to the target artificial intelligence model according to an order specified in the target transformation scenario, without executing the transformed target artificial intelligence model on the target platform.

14. The method of claim 13, further comprising:
comparing the performance verification result of the transformed target artificial intelligence model with a performance prediction value mapped to the target transformation scenario;
determining whether to modify the target transformation scenario based on a result of the comparing, and when it is determined that the target transformation scenario is to be modified, changing a parameter of at least one of the target model optimization tools included in the target transformation scenario; and
performing a second transformation of the target artificial intelligence model by applying the target model optimization tools including the changed parameter to the target artificial intelligence model in its state prior to the transformation.

15. The method of claim 1, wherein the scenario database is constructed by:
receiving first information for identifying a candidate artificial intelligence model and second information for identifying a candidate platform on which the candidate artificial intelligence model is to be executed;
generating a block analysis result for blocks constituting the candidate artificial intelligence model by using the first information, and generating a platform analysis result indicating a constraint for the candidate platform by using the second information;
generating a performance prediction value for a combination of the candidate artificial intelligence model and the candidate platform when a candidate model optimization tool is applied to the candidate artificial intelligence model, by using the block analysis result and the platform analysis result; and
generating a candidate transformation scenario comprising the first information, the second information, the candidate model optimization tool, and the performance prediction value.

16. The method of claim 15, wherein the block analysis result comprises:
an inference accuracy of the candidate artificial intelligence model, predicted in units of a block comprising one or more operators constituting the candidate artificial intelligence model; and
an execution mode of the candidate artificial intelligence model, and
the platform analysis result comprises:
a constraint condition of the candidate platform;
an operator supported by the candidate platform;
a data type supported by the candidate platform; and
an execution unit of the candidate platform.

17. The method of claim 15, wherein the generating the candidate transformation scenario comprises:
generating a first order rule indicating an application order of a plurality of candidate model optimization tools according to an execution mode of the candidate artificial intelligence model, and generating a second order rule indicating the application order of the plurality of candidate model optimization tools by using a correlation between the plurality of candidate model optimization tools; and
generating the candidate transformation scenario including an execution order in which the plurality of candidate model optimization tools are executed on the candidate artificial intelligence model, by using the first order rule and the second order rule.

18. The method of claim 15, wherein the generating the candidate transformation scenario comprises:
generating a performance change prediction value corresponding to each of a plurality of candidate model optimization tools; and
determining a candidate model optimization tool to be matched with the combination of the first information and the second information among the plurality of candidate model optimization tools, in descending order of a quantitative value of performance change within the performance change prediction value and by giving priority to inference speed.

19. A non-transitory computer-readable medium storing a computer program that, when executed by a computing device, causes the computing device to perform operations for transforming an artificial intelligence model for performance optimization of the artificial intelligence model, the operations comprising:
receiving a first query for identifying a target artificial intelligence model to be subjected to transformation, and a second query for identifying a target platform on which the target artificial intelligence model is to be executed;
accessing a scenario database that stores a plurality of transformation scenarios, and determining a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model; and
transforming the target artificial intelligence model by applying target model optimization tools included in the target transformation scenario to the target artificial intelligence model.

20. A computing device for transforming an artificial intelligence model for performance optimization of the artificial intelligence model, the computing device comprising:
at least one processor configured to:
receive a first query for identifying a target artificial intelligence model to be subjected to transformation, and a second query for identifying a target platform on which the target artificial intelligence model is to be executed;
access a scenario database that stores a plurality of transformation scenarios, and determine a target transformation scenario to be applied to the target artificial intelligence model among the plurality of transformation scenarios by using the first query and the second query, wherein each of the plurality of transformation scenarios identifies a combination of model optimization tools to be executed on an artificial intelligence model; and
transform the target artificial intelligence model by applying target model optimization tools included in the target transformation scenario to the target artificial intelligence model.
